(19) United States
(12) Patent Application Publication
(10) Pub. No.: US 2020/0045895 A1
(43) Pub. Date: Feb. 13, 2020

(54) METHODS AND DEVICES FOR STIMULATING GROWTH OF GRAPE VINES, GRAPE VINE REPLANTS OR AGRICULTURAL CROPS

(71) Applicant: Opti-Harvest, Inc., Los Angeles, CA (US)

(72) Inventors: Yosepha SHAHAK RAVID, Visalia, CA (US); Nicholas BOOTH, Los Angeles, CA (US); William L. PEACOCK, Los Angeles, CA (US); Nadav RAVID, Visalia, CA (US); Jonathan DESTLER, Los Angeles, CA (US); Daniel L. FARKAS, Los Angeles, CA (US)

(21) Appl. No.: 16/526,790

(22) Filed: Jul. 30, 2019

Related U.S. Application Data
(63) Continuation of application No. PCT/US2018/065343, filed on Dec. 13, 2018.
(60) Provisional application No. 62/607,738, filed on Dec. 19, 2017.

(51) Int. Cl. A01G 13/02; A01G 7/04; A01G 9/24

(52) U.S. Cl. CPC A01G 13/0225; A01G 9/243; A01G 7/04

(57) ABSTRACT

A growth chamber for improving growing conditions of a growing plant which include a growing grape vine, grape vine replant or other agricultural crop plant. The growth chamber includes a solar concentrator for collecting and concentrating solar energy, a light transmitter in optical communication with the solar concentrator, for directing the collected solar energy toward the growing plant, an inner wall comprising a perimeter positioned between the solar concentrator and the growing grape vine or grape vine replant, the inner wall further comprising a reflective inner surface for directing collected solar energy toward the growing plant, and a protective inner surface configured for placement around the growing plant, the protective inner surface defining a protected zone surrounding the growing plant, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by growing plant positioned in the protected zone.

### CROSS-REFERENCE

This application is a Continuation of International Application No. PCT/US2018/65343 filed Dec. 13, 2018, which claims the benefit of U.S. Provisional Application Ser. No. 62/607,738 filed Dec. 19, 2017, the entirety of which is hereby incorporated by reference herein.

### BACKGROUND OF THE INVENTION

Each year about 10,000 acres of wine grapes are planted in cool climate areas of the state of California, with an average planting density of 800 vines per acre.

In vineyards in California and worldwide, once a vineyard is older than fifteen years of age, vines need to be replaced and the rate of replacement may be 1% in the early years but rise to 5% as the vineyard ages past twenty, due to the onset of disease and other age-related factors in the grape vines. If replacement is deferred, a vineyard in California, cool or hot climate, rarely remains productive past twenty years, and will need to be removed.

A common practice in older vineyards is to plant a new vine on rootstock next to the vine in decline. The weakened vine is either removed immediately or cropped another year or two before removal. The newly planted vine (also referred to as a vine replant) grows rapidly until the end of May, (in the Northern Hemisphere) at which point it becomes shaded by the existing vineyard canopy. Because of shading, growth during the remainder of the season is limited. It takes more than twice as long to establish the replant vine because of shading and other factors limiting the growth rate of the vine replants.

In warmer areas, grape vine replants are shaded by existing vines, resulting in sub-optimal exposure to sunlight, while at the same time being exposed to high ambient temperatures. As a result, the growth of these vines toward fruit production may be limited by excessive heat and wind, leading to plant damage and high evapo-transpiration, while experiencing reduced growth due to sub-optimal sunlight caused by shading.

When new vineyards are initially planted, shading of newly planted vines by existing vines is not a problem. However, in these cases, growth toward fruit production of the newly planted vines is often limited by numerous factors other than shading. Among the factors limiting growth rate, depending on climate and other factors, may be wind, frost, animal damage, heat damage, cold damage, and herbicide damage.

Upon reading this disclosure, it will become obvious to the reader that methods and devices disclosed herein are equally applicable to a wide variety of agricultural cash crops.

### SUMMARY OF THE INVENTION

Provided herein is a method of collecting and concentrating solar energy to an agricultural cash crop, comprising: collecting and concentrating solar energy with a solar concentrator comprising a solar-facing surface positioned above the agricultural cash crop, the solar-facing surface comprising a reflective material; directing the collected solar energy toward the agricultural cash crop through a light transmitter in optical communication with the solar concentrator, the light transmitter comprising: an inner wall comprising a perimeter positioned between the solar concentrator and the agricultural cash crop, the inner wall further comprising a rugged or textured reflective inner surface for directing and scattering collected solar energy light and heat toward the agricultural cash crop. In some embodiments, the method further comprises positioning a protective inner surface defining a protected zone surrounding the agricultural cash crop, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by a grape vine positioned in the protected zone. In some embodiments of the method, collecting and concentrating the solar energy to the agricultural cash crop improves the growing conditions of the agricultural cash crop. In some embodiments of the method, the protective inner surface and the light transmitter are integrally connected to one another. In some embodiments of the method, the protective inner surface, the light transmitter and solar concentrator are integrally connected to one another. In some embodiments of the method, one or both of the light transmitter and the protective inner surface comprise one or more openings for allowing one or both of a) operator access to the growing grape vine or grape vine replants therethrough and b) airflow between the outside environment and the protected zone. In some embodiments of the method, two or more of the openings are arranged in pairs positioned on laterally opposing sides of the light transmitter or protective inner surface from one another, to allow lateral airflow through the light transmitter or protective inner surface. In some embodiments of the method, the solar concentrator comprises a funnel shape, a cone shape, a parabolic shape, a partial funnel shape, a partial cone shape a compound or partial parabolic shape. In some embodiments of the method, one or both of the reflective material and the reflective inner surface comprise a plastic material. In some embodiments of the method, one or both of the reflective material and the reflective inner surface are red in color. In some embodiments of the method, one or both of the reflective material and the reflective inner surface are adapted to limit or eliminate reflection of blue light. In some embodiments of the method, one or both of the reflective material are adapted to limit or eliminate reflection of UV light. In some embodiments of the method, the rigid outer wall defines an upper perimeter for engaging the light transmitter and a lower perimeter for engaging the soil surface surrounding the growing grape vine or grape vine replant, and wherein the lower perimeter is smaller than the upper perimeter. In some embodiments of the method, one or both of the light transmitter and the protective inner surface comprise one or more vertical openings comprising: edges, joints and a hinge, such that one or both of the light transmitter and the protective inner surface is configurable to be opened or closed along the vertical opening, thereby allowing air to pass the outside environment and the protected zone. In some embodiments, the method further comprises placement of a heat sink in one or both of the light transmitter and the protective inner surface, for gathering the concentrated solar heat energy in the heat sink at one time and releasing the gathered solar heat energy into the protected zone at a later time. In some embodiments of the method, the protective inner surface and the light transmitter are connected to one another through an interlocking connection. In some embodiments of the method, the solar concentrator and the light transmitter are connected to one another through an interlocking connection. In some embodiments of the method, the solar concentrator, the light transmitter and the protective inner surface are connected to one another through an interlocking connection. In some embodiments of the method, the solar concentrator and the light transmitter are connected to one another through a rotary connection. In some embodiments of the method, the rigid outer wall defines a funnel shape, a cone shape, a parabolic shape, a partial funnel shape, a partial cone shape a compound or partial parabolic shape. In some embodiments of the method, the rigid outer wall defines an upper perimeter for engaging the light transmitter and a lower perimeter for engaging the soil surface surrounding the growing grape vine or grape vine replant, and wherein the lower perimeter is smaller than the upper perimeter. In some embodiments of the method, the protective inner surface is supported on the soil surrounding the growing grape vine or grape vine replant on one, two, three, four, or more legs extending from the protective inner surface or from the light transmitter. In some embodiments of the method, one or both of the light transmitter and the protective inner surface are tube shaped. In some embodiments of the method, the heat sink is circular in shape defining an opening for surrounding the growing grape vine or grape vine replant. In some embodiments of the method, the heat sink comprises one circular portion or two or more partial portions that engage one another to form the circular shape. In some embodiments, the method comprises a step of training the growing grape vine or grape vine replant to grow in a desired direction by positioning the one or more of the protective inner surface or sleeve portions and the inner wall adjacent to the growing grape vine or grape vine replant and in a desired direction. In some embodiments, the method further comprises scattering, manipulating the spectral composition, or both, of the collected solar energy before the collected solar energy is directed to the surface of the growing grape vine or grape vine replant. In some embodiments of the method, the manipulating of the spectral composition comprises reducing blue light, enriching relative content of light in the yellow or red or far-red spectral regions, reducing relative content of UV radiation, reducing relative content of UVB radiation, or any combination thereof. In some embodiments of the method, the manipulating of the spectral composition comprises enriching relative content of light in each of the yellow, red or far-red spectral regions by at least about 10%. In some embodiments of the method, the manipulating of the spectral composition comprises enriching relative content of light in each of the yellow, red or far-red spectral regions by at least about 20%. In some embodiments of the method, the manipulating of the spectral composition comprises enriching photosynthetically active radiation (PAR) ranges from about 400-700 nm, about 570-750 nm and/or about 620-750 nm. In some embodiments of the method, the manipulating of the spectral composition comprises reducing blue light by at least about 20%. In some embodiments of the method, the manipulating of the spectral composition comprises reducing relative content of UVB radiation by at least about 50%. In some embodiments of the method, the manipulating of the spectral composition comprises reducing relative content of Infrared radiation (IR). In some embodiments of the method, the manipulating of the spectral composition comprises reducing relative content of Infrared radiation (IR) greater than at least about 750 nm. In some embodiments, the method further comprises filtering the spectral composition light ranges within wavelengths from about 400-700 nm, about 540-750 nm and/or about 620-750 nm, and frequencies from about 508-526 THz and about 400-484 THz. In some embodiments of the method, the manipulating of the spectral composition comprises reducing relative content of UVB radiation by at least about 50%.

Provided herein is a growth chamber for a grape vine, the growth chamber comprising: a solar concentrator for collecting and concentrating solar energy, the solar concentrator comprising a solar-facing surface positioned above the agricultural cash crop, the solar-facing surface comprising a reflective material; a light transmitter in optical communication with the solar concentrator, for directing the collected solar energy toward the agricultural cash crop therethrough, the light transmitter comprising: an inner wall comprising a perimeter positioned between the solar concentrator and the agricultural cash crop, the inner wall further comprising a reflective inner surface for directing collected solar energy toward the agricultural cash crop. In some embodiments, the growth chamber further comprising a protective inner surface configured for placement around the growing grape vine or grape vine replant, the protective inner surface defining a protected zone surrounding the growing grape vine or grape vine replant, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by a grape vine positioned in the protected zone. In some embodiments of the growth chamber, the protective inner surface and the light transmitter are integrally connected to one another. In some embodiments of the growth chamber, the protective inner surface, the light transmitter and solar connector are integrally connected to one another. In some embodiments of the growth chamber, one or both of the light transmitter and the protective inner surface comprise one or more openings for allowing one or both of a) operator access to the growing grape vine or grape vine replants therethrough and b) airflow between the outside environment and the protected zone. In some embodiments of the growth chamber, two or more of the openings are arranged in pairs positioned on laterally opposing sides of the light transmitter or protective inner surface from one another, to allow lateral airflow through the light transmitter or protective inner surface. In some embodiments of the growth chamber, the one or more openings are positioned either randomly or systematically in a pattern. In some embodiments of the growth chamber, the one or more openings comprise from about 1 to about 20 openings. In some embodiments of the growth chamber, the one or more openings are positioned at variable heights relative to each other. In some embodiments of the growth chamber, the one or more openings comprise diameters having a functional range from about 1.0 inch and about 12.0 inches and need not all be the same diameter. In some embodiments of the growth chamber, the solar concentrator comprises a cone shape, a funnel shape, a parabolic shape, a partial funnel shape, a partial cone shape a compound or partial parabolic shape. In some embodiments of the growth chamber, one or both of the reflective material and the reflective inner surface comprise a plastic material. In some embodiments of the growth chamber, one or both of the reflective material and the reflective inner surface are red in color. In some embodiments of the growth chamber, one or both of the reflective material are adapted to limit or eliminate reflection of blue light. In some embodiments of the growth chamber, one or both of the reflective material and the reflective inner surface are adapted to limit or eliminate reflection of UV light. In some embodiments of the growth chamber, the rigid outer wall defines an upper perimeter for engaging the light transmitter and a lower perimeter for engaging the soil surface surrounding the growing grape vine or grape vine replant, and wherein the lower perimeter is smaller than the upper perimeter. In some embodiments of the growth chamber, one or both of the light transmitter and the protective inner surface comprise one or more vertical openings comprising; edges, joints or a hinge, such that one or both of the light transmitter and protective inner surface is configurable to be opened or closed along the vertical opening, thereby allowing air to pass the outside environment and the protected zone. In some embodiments, the growth chamber further comprises a heat sink in one or both of the light transmitter and the protective inner surface, for gathering the concentrated solar heat energy in the heat sink at one time and releasing the gathered solar heat energy into the protected zone at a later time. In some embodiments of the growth chamber, the protective inner surface and the light transmitter are connected to one another through an interlocking connection. In some embodiments of the growth chamber, the solar concentrator and the light transmitter are connected to one another through an interlocking connection. In some embodiments of the growth chamber, the solar concentrator, the light transmitter and the protective inner surface are connected to one another through an interlocking connection. In some embodiments of the growth chamber, the solar concentrator and the light transmitter are connected to one another through a rotary connection. In some embodiments of the growth chamber, the rigid outer wall defines a funnel shape. In some embodiments of the growth chamber, the rigid outer wall defines an upper perimeter for engaging the light transmitter and a lower perimeter for engaging the soil surface surrounding the growing grape vine or grape vine replant, and wherein the lower perimeter is smaller than the upper perimeter. In some embodiments of the growth chamber, the protective inner surface is supported on the soil surrounding the growing grape vine or grape vine replant on one, two, three, four, or more legs extending from the protective inner surface or from the light transmitter. In some embodiments of the growth chamber, one or both of the light transmitter and the protective inner surface are tube shaped. In some embodiments of the growth chamber, the heat sink is circular in shape defining an opening for surrounding the growing grape vine or grape vine replant. In some embodiments of the growth chamber, the heat sink comprises one circular portion or two or more partial circular portions that engage one another to form the circular shape. In some embodiments of the growth chamber, one or both of the protective inner surface and the light transmitter are adapted to train the growing grape vine or grape vine replant to grow in a desired direction. In some embodiments of the growth chamber, the solar-facing surface, the reflective inner surface, an inner wall of the protective inner surface, or any combination thereof, is adapted to scatter, manipulate the spectral composition, or both, of the collected solar energy before the collected solar energy is directed to the surface of the growing grape vine or grape vine replant. In some embodiments of the growth chamber, the manipulation of the spectral composition comprises reducing blue light, enriching relative content of light in the yellow and red or far-red spectral regions, reducing relative content of UV radiation, reducing relative content of UVB radiation, or any combination thereof. It should be noted that typically the Yellow composition is reflecting/enriching all spectral bands from Yellow and up (Y+R+FR), and the Red composition is reflecting/enriching in the R+FR bands. In some embodiments of the growth chamber, the manipulation of the spectral composition comprises enriching relative content of light in each of the yellow, red or far-red spectral regions by at least about 10%. In some embodiments of the growth chamber, the manipulating of the spectral composition comprises enriching relative content of light in each of the yellow, red or far-red spectral regions by at least about 20%. In some embodiments of the growth chamber, the manipulating of the spectral composition comprises reducing blue light by at least about 20%. In some embodiments of the growth chamber, the manipulating of the spectral composition comprises reducing relative content of UVB radiation by at least about 50%. In some embodiments of the growth chamber, the manipulation of the spectral composition comprises enriching photosynthetically active radiation (PAR) ranges from about 400-700 nm, about 540-750 nm and/or about 620-750 nm. In some embodiments of the growth chamber, the manipulating of the spectral composition comprises reducing relative content of Infrared radiation (IR). In some embodiments of the growth chamber, the manipulating of the spectral composition comprises reducing relative content of Infrared radiation (IR) greater than at least about 750 nm. In some embodiments, the growth chamber further comprises filtering the spectral composition light ranges within wavelengths from about 400-700 nm, about 540-750 nm and/or about 620-750 nm, and frequencies from about 508-526 THz and about 400-484 THz.

Provided herein is a method of improving growing conditions of a growing plant, the method comprising: collecting and concentrating solar energy with a solar concentrator comprising a solar-facing surface positioned above the growing plant, the solar-facing surface comprising a reflective material; directing the collected solar energy toward the growing plant through a light transmitter in optical communication with the solar concentrator, the light transmitter comprising: an inner wall comprising a perimeter positioned between the solar concentrator and the growing plant, the inner wall further comprising a reflective inner surface for directing collected solar energy toward the growing plant. In some embodiments, the method further comprises positioning a protective inner surface defining a protected zone surrounding the growing plant, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by a grape vine positioned in the protected zone; thereby directing the concentrated solar energy to the growing plant, protecting the growing plant from the one or more growth limiting factors, and improving growing conditions of the growing plant. In some embodiments of the method, collecting and concentrating the solar energy to the growing plant improves the growing conditions of the growing plant. In some embodiments of the method, the protective inner surface and the light transmitter are integrally connected to one another.

In some embodiments of the method, the protective inner surface, the light transmitter and the solar concentrator are integrally connected to one another. In some embodiments of the method, one or both of the light transmitter and the protective inner surface comprise one or more openings for allowing one or both of a) operator access to the growing plants therethrough and b) airflow between the outside environment and the protected zone. In some embodiments of the method, two or more of the openings are arranged in pairs positioned on laterally opposing sides of the light transmitter or protective inner surface from one another, to allow lateral airflow through the light transmitter or protective inner surface. In some embodiments of the method, the solar concentrator comprises a cone shape, a funnel shape, a parabolic shape, a partial funnel shape, a partial cone shape, a compound or partial parabolic shape. In some embodiments of the method, one or both of the reflective material and the reflective inner surface comprise a plastic material. In some embodiments of the method, one or both of the reflective material and the reflective inner surface are red in color. In some embodiments of the method, one or both of the reflective material and the reflective inner surface are adapted to limit or eliminate reflection of blue light. In some embodiments of the method, one or both of the reflective material and the reflective inner surface are adapted to limit or eliminate reflection of UV light. In some embodiments of the method, the rigid outer wall defines an upper perimeter for engaging the light transmitter and a lower perimeter for engaging the soil surface surrounding the growing plant, and wherein the lower perimeter is smaller than the upper perimeter. In some embodiments of the method, one or both of the light transmitter and the protective inner surface comprise one or more vertical openings comprising; edges, joints or a hinge, such that one or both of the light transmitter and the protective inner surface is configurable to be opened or closed along the vertical opening, thereby allowing air to pass the outside environment and the protected zone. In some embodiments, the method further comprises placement of a heat sink in one or both of the light transmitter and the protective inner surface, for gathering the concentrated solar heat energy in the heat sink at one time and releasing the gathered solar heat energy into the protected zone at a later time. In some embodiments of the method, the protective inner surface and the light transmitter are connected to one another through an interlocking connection. In some embodiments of the method, the solar concentrator and the light transmitter are connected to one another through an interlocking connection. In some embodiments of the method, the solar concentrator and the light transmitter are connected to one another through a rotary connection. In some embodiments of the method, the rigid outer wall defines a funnel shape, a cone shape, a parabolic shape, a partial funnel shape, a partial cone shape, a compound or partial parabolic shape. In some embodiments of the method, the rigid outer wall defines an upper perimeter for engaging the light transmitter and a lower perimeter for engaging the soil surface surrounding the growing plant, and wherein the lower perimeter is smaller than the upper perimeter. In some embodiments of the method, the protective inner surface is supported on the soil surrounding the growing plant on one, two, three, four, or more legs extending from the protective inner surface or from the light transmitter. In some embodiments of the method, one or both of the light transmitter and the protective inner surface are tube shaped. In some embodiments of the method, the heat sink is circular in shape defining an opening for surrounding the growing plant. In some embodiments of the method, the heat sink comprises one circular portion or two or more partial circular portions that engage one another to form the circular shape. In some embodiments, the method further comprises a step of training the growing plant to grow in a desired direction by positioning the one or more of the protective inner surface or sleeve portions and the inner wall adjacent to the growing plant and in a desired direction. In some embodiments, the method further comprises scattering, manipulating the spectral composition, or both, of the collected solar energy before the collected solar energy is directed to the surface of the growing plant. In some embodiments of the method, the manipulating of the spectral composition comprises reducing blue light, enriching relative content of light in the yellow and red or far-red spectral regions, reducing relative content of UV radiation, reducing relative content of UVB radiation, or any combination thereof. In some embodiments of the method, the manipulating of the spectral composition comprises enriching relative content of light in each of the yellow, red and/or far-red spectral regions by at least about 10%. In some embodiments of the method, the manipulating of the spectral composition comprises enriching relative content of light in each of the yellow, red and/or far-red spectral regions by at least about 20%. In some embodiments of the method, the manipulating of the spectral composition comprises enriching photosynthetically active radiation (PAR) ranges from about 400-700 nm, about 570-750 nm and/or about 620-750 nm. In some embodiments of the method, the manipulating of the spectral composition comprises reducing blue light by at least about 20%. In some embodiments of the method, the manipulating of the spectral composition comprises reducing relative content of UVB radiation by at least about 50%. In some embodiments of the method, the manipulating of the spectral composition comprises reducing relative content of Infrared radiation (IR). In some embodiments of the method, the manipulating of the spectral composition comprises reducing relative content of Infrared radiation (IR) greater than at least about 750 nm. In some embodiments, the method further comprises filtering the spectral composition light ranges within wavelengths from about 400-700 nm, about 540-750 nm and/or about 620-750 nm, and frequencies from about 508-526 THz and about 400-484 THz.

Provided herein is a growth chamber for improving growing conditions of a growing plant, the growth chamber comprising: a solar concentrator for collecting and concentrating solar energy, the solar concentrator comprising a solar-facing surface positioned above the growing plant, the solar-facing surface comprising a reflective material; a light transmitter in optical communication with the solar concentrator, for directing the collected solar energy toward the growing plant therethrough, the light transmitter comprising: an inner wall comprising a perimeter positioned between the solar concentrator and the growing plant, the inner wall further comprising a reflective inner surface for directing collected solar energy toward the growing plant. In some embodiments, the growth chamber further comprises: a protective inner surface configured for placement around the growing plant, the protective inner surface defining a protected zone surrounding the growing plant, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by a grape vine positioned in the protected zone. In some embodiments, the protective inner surface and the light transmitter are integrally connected to one another. In some embodiments, the protective inner surface and the light transmitter are integrally connected to one another. In some embodiments, one or both of the light transmitter and the protective inner surface comprise one or more openings for allowing one or both of a) operator access to the growing plants therethrough and b) airflow between the outside environment and the protected zone. In some embodiments, two or more of the openings are arranged in pairs positioned on laterally opposing sides of the light transmitter or protective inner surface from one another, to allow lateral airflow through the light transmitter or protective inner surface. In some embodiments, the one or more openings are positioned either randomly or systematically in a pattern. In some embodiments, the one or more openings comprise from about 1 to about 20 openings. In some embodiments, the one or more openings are positioned at variable heights relative to each other. In some embodiments, the one or more openings comprise diameters having a functional range from about 1.0 inch and about 12.0 inches and need not all be the same diameter. In some embodiments, the solar concentrator comprises a funnel shape, a cone shape, a parabolic shape, a partial funnel shape, a partial cone shape, a compound or partial parabolic shape. In some embodiments, one or both of the reflective material and the reflective inner surface comprise a plastic material. In some embodiments, one or both of the reflective material and the reflective inner surface are red in color. In some embodiments, one or both of the reflective material are adapted to limit or eliminate reflection of blue light. In some embodiments, one or both of the reflective material are adapted to limit or eliminate reflection of UV light. In some embodiments, the rigid outer wall defines an upper perimeter for engaging the light transmitter and a lower perimeter for engaging the soil surface surrounding the growing plant, and wherein the lower perimeter is smaller than the upper perimeter. In some embodiments, one or both of the light transmitter and the protective inner surface comprise a vertical opening and a hinge, such that one or both of the light transmitter and the growth tube is configured to be opened or closed along the vertical opening, thereby allowing air to pass the outside environment and the protected zone. In some embodiments, the growth chamber further comprises a heat sink in one or both of the light transmitter and the protective inner surface, for gathering the concentrated solar heat energy in the heat sink at one time and releasing the gathered solar heat energy into the protected zone at a later time. In some embodiments, the protective inner surface and the light transmitter are connected to one another through an interlocking connection. In some embodiments, the solar concentrator and the light transmitter are connected to one another through an interlocking connection. In some embodiments, the solar concentrator, the light transmitter and the protective inner surface are connected to one another through an interlocking connection. In some embodiments, the solar concentrator and the light transmitter are connected to one another through a rotary connection. In some embodiments, the rigid outer wall defines a funnel shape. In some embodiments, the rigid outer wall defines an upper perimeter for engaging the light transmitter and a lower perimeter for engaging the soil surface surrounding the growing plant, and wherein the lower perimeter is smaller than the upper perimeter. In some embodiments, the protective inner surface is supported on the soil surrounding the growing plant on one, two, three, four, or more legs extending from the protective inner surface or from the light transmitter. In some embodiments, one or both of the light transmitter and the protective inner surface are tube shaped. In some embodiments, the heat sink is circular in shape defining an opening for surrounding the growing plant. In some embodiments, the heat sink comprises one circular portion or two semicircular portions that engage one another to form the circular shape. In some embodiments, one or both of the protective inner surface and the light transmitter are adapted to train the growing plant to grow in a desired direction. In some embodiments, the solar-facing surface, the reflective inner surface, an inner wall of the protective inner surface, or any combination thereof, is adapted to scatter, manipulate the spectral composition, or both, of the collected solar energy before the collected solar energy is directed to the surface of the growing plant. In some embodiments, the manipulation of the spectral composition comprises reducing blue light, enriching relative content of light in the yellow or red or far-red spectral regions, reducing relative content of UV radiation, reducing relative content of UVB radiation, or any combination thereof. In some embodiments, the manipulation of the spectral composition comprises enriching relative content of light in each of the yellow, red and/or far-red spectral regions by at least about 10%. In some embodiments, the manipulating of the spectral composition comprises enriching relative content of light in each of the yellow, red and/or far-red spectral regions by at least about 20%. In some embodiments, the manipulating of the spectral composition comprises reducing blue light by at least about 20%. In some embodiments, the manipulating of the spectral composition comprises reducing relative content of UVB radiation by at least about 50%. In some embodiments, the manipulation of the spectral composition comprises enriching photosynthetically active radiation (PAR) ranges from about 400-700 nm, about 540-750 nm and/or about 620-750 nm. In some embodiments, the manipulating of the spectral composition comprises reducing relative content of Infrared radiation (IR). In some embodiments, the manipulating of the spectral composition comprises reducing relative content of Infrared radiation (IR) greater than at least about 750 nm. In some embodiments, the growth chamber further comprises filtering the spectral composition light ranges within wavelengths from about 400-700 nm, about 540-750 nm and/or about 620-750 nm, and frequencies from about 508-526 THz and about 400-484 THz.

Provided herein is a growth chamber comprising: a solar concentrator for collecting and concentrating solar energy, the solar concentrator comprising a solar-facing surface positioned above a crop plant, the solar-facing surface comprising reflective material; a light transmitter in optical communication with the solar concentrator, for directing the collected solar energy toward the crop plant therethrough, the light transmitter comprising: an inner wall forming a protective zone around the crop plant, comprising a perimeter positioned between the solar concentrator and the crop plant, the inner wall further comprising reflective inner surface for directing collected solar energy toward the crop plant. In some embodiments, the reflective material is an adjustable photoselective reflective material. In some embodiments, the solar-facing surface comprises an offset superior collar extending around a portion of the solar concentrator. In some embodiments, the collected solar energy comprises selected wavelengths. In some embodiments, the growth chamber further comprises: a textured surface on the inner wall surface of the light transmitter to provide a level of control of light levels and/or spatial light positioning around the crop plant within a downtube of the light transmitter. In some embodiments, the adjustable photoselective reflective inner surface color is a shade of red specifically intended to affect light with light of at least one wavelength selected from the range of wavelengths from 400 nm to 700 nm. In some embodiments, the growth chamber further comprises a polarized reflective outer surface coating. In some embodiments, the growth chamber further comprises a textured surface on the outer wall surface of the light transmitter. In some embodiments, the growth chamber further comprises a separable light transmitter base, being a secondary component of the growth chamber. In some embodiments, the solar concentrator and the light transmitter of the growth chamber are separable, either independently or together, into two or more pieces. In some embodiments, the solar concentrator and the light transmitter of the growth chamber are separable along one or more horizontal planes. In some embodiments, the solar concentrator and the light transmitter of the growth chamber are jointly separable along a vertical plane. In some embodiments, the solar concentrator and the light transmitter of the growth chamber are jointly separable along a vertical plane and further comprise assembly components along vertical edges formed at the intersection of the solar concentrator and the light transmitter and the vertical plane. In some embodiments, the growth chamber further comprises one or more openings in the light transmitter. In some embodiments, the one or more openings provide one or both of: a) operator access to the crop plant therethrough, and b) airflow between the outside environment and an interior of the light transmitter. In some embodiments, the perimeter of the jointly separable components of the growth chamber is expandable such that a first pair of mating vertical edges of the separable components are connectable by hinging mechanisms allowing the growth chamber to book open along a second pair of vertical edges of the separable components. In some embodiments, the second pair of vertical edges of the separable components are releasably connectable by at least one extension panel comprising one or more attachment receivers for connecting to one or more attachment features along the second pair of vertical edges of the separable components. In some embodiments, the textured outer wall comprises pest-control aide color selected from the group consisting of: yellow; pearl-white; highly reflective metallic silver or gold; and adjacent shades in the spectrum thereof. In some embodiments, the textured outer wall comprises: an external reflective polarization material coating comprising; a nano-particle coating; a photochromic treatment; a polarized treatment; a tinting treatment; a scratch resistant treatment; a mirror coating treatment; a hydro-phobic coating treatment; an oleo-phobic coating treatment; or a combination thereof, wherein the reflective polarization coating reflects light comprising a selected spectrum of wavelengths can be chosen according to a known behavior of an arthropod of interest. In some embodiments, the spectrum is selected according to known characteristics of an arthropod of interest. In some embodiments, the reflective polarization coating reflects light comprising a selected spectrum of wavelengths, the wavelengths consisting of light falling within a spectral range selected from the group consisting of: UV, blue, green, yellow, and red.

Provided herein is a light-reflective growth stimulator for enriching a light environment to a crop plant comprising: a flexible reflective panel comprising a first photoselective reflective surface having properties for directing solar energy comprising selected red light wavelengths toward the crop plant and placed in proximity to said agricultural crop plant, wherein the photoselective reflective surface reduces blue light wavelengths directed toward the agricultural crop plant. In some embodiments, the flexible reflective panel further comprises a plurality of wind resistance reduction features. In some embodiments, the flexible reflective panel comprises photoselective netting. In some embodiments, the flexible reflective panel comprises a second photoselective reflective surface having properties for spectral manipulation of light for insect pest control, wherein the second photoselective reflective surface reflects light selected according to known characteristics of an arthropod of interest. In some embodiments, the flexible reflective panel is a shade of red specifically intended to affect light with light of at least one wavelength selected from the range of wavelengths of from 400 nm to 700 nm. In some embodiments, a side opposite the reflective surface reflects light comprising a selected spectrum of wavelengths, the wavelengths consisting of light falling within a spectral range selected from the group consisting of: yellow; pearl-white; highly reflective metallic silver or gold; and adjacent shades in the spectrum thereof. In some embodiments, the growth chamber is covered or “capped” with a transparent material, e.g. plastic, to protect the grape vine, grape vine replant, or any crop plant therein, from severe atmospheric elements such as during winter time in very cold climates to protect from snow, frost, hail, etc. In some embodiments, the side access holes of the growth chamber are covered with a transparent material, e.g. plastic, or a hole cap to protect the grape vine, grape vine replant, or any crop plant therein, from severe atmospheric elements such as during winter time in very cold climates to protect from snow, frost, hail, and similar negative environmental conditions. In some embodiments, the growth chambers of the present disclosure (and or numerous variants contemplated and described herein herein, will be utilized for other plant species/crops and agricultural sub-industries that would benefit from this technology. Among those other plant species/crops and agricultural sub-industries anticipated comprise: Outdoor tree nurseries (fruit and/or ornamental plant production); orchard replants (e.g. citrus, avocado, stone-fruits); newly planted fruit trees; and Herbaceous crops, (e.g.; especially Cannabis); to name but a few.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIGS. 1A-1D depict a non-limiting illustration of exemplary growth chambers. FIG. 1A depicts an exemplary growth chamber including a cone shaped solar concentrator; FIG. 1B depicts an exemplary partial cone shaped solar concentrator; FIG. 1C depicts an exemplary partial cone shaped solar concentrator with a tubular, cylindrical short-stacked protective inner surface; and FIG. 1D depicts an exemplary growth chamber assembly with only a light transmitter and funnel shaped protective inner surface;

FIGS. 2A-2G depict non-limiting illustrations of exemplary solar concentrators. FIGS. 2A and 2C depict an exemplary, cone-shaped, solar concentrator and FIGS. 2B and 2D depict an exemplary, partial cone shaped, solar concentrator. FIG. 2E depicts an exemplary, non-limiting asymmetric-shaped, solar concentrator configuration. The illustrated asymmetric configuration comprises two parabolic curves, which are variably adjustable, combined to collect all light between selectable ranges of solar altitudes. FIG. 2F depicts an exemplary truncated version of the non-limiting representation of the compound parabolic solar concentrator of FIG. 2D to allow for attachment to a light transmitter of the exemplary growth chambers. FIG. 2G depicts a representation of the attachment of the truncated parabolic solar concentrator to a light transmitter;

FIGS. 3A-3H depict non-limiting illustrations of exemplary light transmitters. FIGS. 3A and 3C depict an exemplary light transmitter having a vertical hinge and a vertical opening in a closed position, and FIGS. 3B and 3D depict an exemplary light transmitter having a vertical hinge and a vertical opening in an open position. FIG. 3E depicts an exemplary growth chamber having vertical edges in a halved-assembly configuration in an open position before clamping. FIG. 3F depicts an exemplary halved-assembly light transmitter, assembled with clamps on both vertical edges in a closed position, and FIG. 3G depicts an exemplary halved-assembly short-stacked cylindrical protective inner surface, assembled with clamps on both vertical edges in a closed position. FIG. 3H depicts an exemplary assembly process for clamping components of a halved assembly growth chamber together at the clamp joints using said clamps;

FIGS. 4A-4D depicts non-limiting illustrations of exemplary light transmitter bases. FIGS. 4A and 4C depict an exemplary light transmitter bases having a vertical hinge and a vertical opening in a closed position, and FIGS. 4B and 4D depict an exemplary light transmitter bases having a vertical hinge and a vertical opening in an open position;

FIGS. 5A-5D depicts another variation of non-limiting illustrations of exemplary light transmitter bases having a protective inner surfaces. FIGS. 5A and 5C depict a conic-shaped light transmitter bases having a protective inner surface having integral external legs or feet, a vertical hinge and a vertical opening in a closed position, and FIGS. 5B and 5D depict a conic-shaped light transmitter bases having a protective inner surface having integral external legs or feet, a vertical hinge and a vertical opening in an open position;

FIGS. 6A-6B depicts non-limiting illustrations of an exemplary heat sink. FIG. 6A depicts an exemplary heat sink separate from and exterior to a growth chamber, and FIG. 6B depicts an exemplary heat sink placed within a light transmitter or an exemplary short-stacked protective inner surface of a growth chamber;

FIG. 7 depicts a right top isometric view of another non-limiting illustration of an exemplary growth chamber having a textured light-reflective interior and exterior surface;

FIG. 8 depicts a left isometric view of a distal portion of an open light transmitter, light transmitter base and removable light transmitter base cover of the exemplary growth chamber of FIG. 7.

FIG. 9 depicts a top left isometric view of a hinged-open growth chamber having solar concentrator, light transmitter, light transmitter base and removable light transmitter base cover of the exemplary growth chamber of FIG. 7.

FIG. 10 depicts a top view of a hinged-open growth chamber having solar concentrator, light transmitter, light transmitter base and removable light transmitter base cover of the exemplary growth chamber of FIG. 7.

FIG. 11 depicts a front view of a hinged-open growth chamber having solar concentrator, light transmitter, light transmitter base and removable light transmitter base cover of the exemplary growth chamber of FIG. 7.

FIG. 12 depicts a left top isometric view of a hinged-open growth chamber having solar concentrator, light transmitter, light transmitter base and removable light transmitter base cover of the exemplary growth chamber of FIG. 7.

FIG. 13 depicts a left side view of a solar concentrator and light transmitter of the exemplary growth chamber of FIG. 7.

FIG. 14 depicts a detail partial side view of a light transmitter and lower portion of the solar concentrator of the exemplary growth chamber of FIG. 7.

FIG. 15 depicts a detail partial back side view of a light transmitter and lower portion of the solar concentrator of the exemplary growth chamber of FIG. 7.

FIG. 16 depicts a back view of a closed growth chamber having solar concentrator, light transmitter and light transmitter base of the exemplary growth chamber of FIG. 7.

FIG. 17 depicts a front view of a closed growth chamber having solar concentrator, light transmitter and light transmitter base of the exemplary growth chamber of FIG. 7.

FIG. 18 depicts a side view of a closed growth chamber having solar concentrator, light transmitter and light transmitter base of the exemplary growth chamber of FIG. 7.

FIG. 19 depicts an isometric side view of the interior of a half-section of a growth chamber having solar concentrator, light transmitter and light transmitter base of the exemplary growth chamber of FIG. 7.

FIG. 20A depicts an isometric left front view of the distal portion of the light transmitter, light transmitter base and removable light transmitter base cover of the exemplary growth chamber of FIG. 7.

FIG. 20B depicts a left side view of the distal portion of the light transmitter, light transmitter base and removable light transmitter base cover of the exemplary growth chamber of FIG. 7.

FIG. 21A depicts an isometric right front view of the distal portion of the light transmitter, light transmitter base and removable light transmitter base cover of the exemplary growth chamber of FIG. 7.

FIG. 21B depicts a detailed isometric right front view of the connection mechanism between the light transmitter and/or light transmitter base and the removable light transmitter base cover of the exemplary growth chamber of FIG. 7.

FIG. 22 depicts an isometric view of another non-limiting illustration of an exemplary flexible reflective panel comprising a reflective surface having properties for directing solar energy toward a crop plant.

FIG. 23 depicts an isometric view of another non-limiting illustration of an exemplary flexible reflective panel comprising a reflective surface having properties for directing solar energy toward a crop plant.

FIG. 24 depicts an isometric view of another non-limiting illustration of an exemplary flexible reflective panel surface comprising a reflective screen or mesh having properties for directing solar energy toward a crop plant.

FIG. 25 depicts exemplary test results for daily trunk diameter growth with different treatments.

FIG. 26 depicts exemplary test results for average trunk diameters.

FIG. 27 depicts exemplary test results for average shoot lengths.

FIG. 28 depicts exemplary test results for percentages of tripped vines.

FIG. 29 depicts exemplary test results for lateral growths.

FIG. 30 depicts exemplary test results for shoot growths.

### DETAILED DESCRIPTION OF THE INVENTION

The disclosure provided herein provides for a growth chamber and uses thereof. The growth chamber is useful for improving growing conditions of a growing plant, and is particularly useful for improving growing conditions of a growing grape vine, grape vine replant or any number of agricultural crop plants during various stages of growth.

Provided herein is a growth chamber for improving growing conditions of a growing plant which include a growing grape vine, grape vine replant or other agricultural crop plant or crop plant. The growth chamber includes a solar concentrator for collecting and concentrating solar energy, a light transmitter in optical communication with the solar concentrator, for directing the collected solar energy toward the growing plant, an inner wall comprising a perimeter positioned between the solar concentrator and the growing grape vine or grape vine replant, the inner wall further comprising a reflective inner surface for directing collected solar energy toward the growing plant, and the protective inner surface configured for placement around the growing plant, the protective inner surface defining a protected zone surrounding the growing plant, the protective inner surface extending downward from the light transmitter and comprising a rigid outer wall for protecting the protected zone from one or more growth limiting factors selected from the group consisting of: wind damage; heat damage; cold damage; frost damage; snow damage, hail damage, herbicide damage; and animal damage; and/or for reducing evapo-transpiration by growing plant positioned in the protected zone. Further still, the growth chamber still provides for aeration (ventilation; gas-exchange) and accessibility for vine training practices.

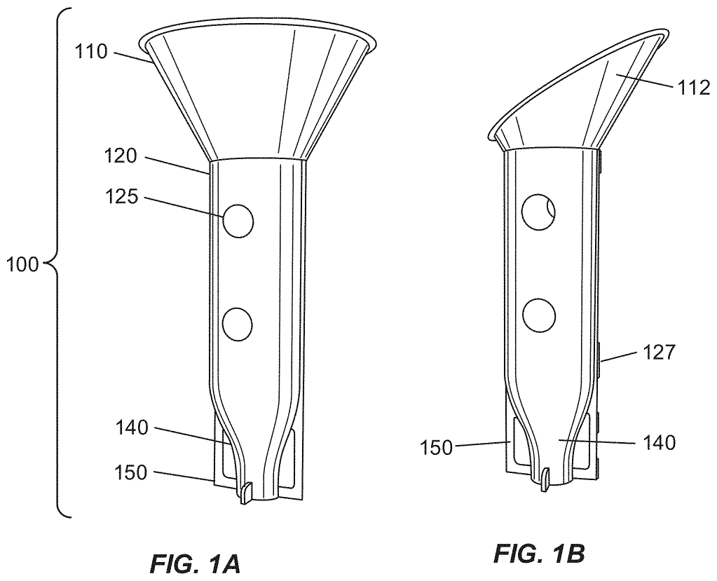

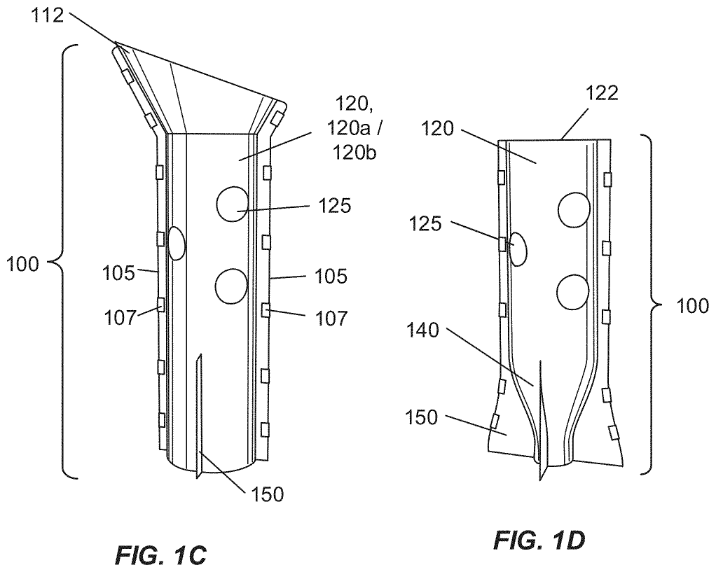

FIGS. 1A-1D depict exemplary growth chambers of the present disclosure, placed in a grape vineyard for context. Growth chamber embodiments of the present disclosure are composed of a variety of suitable materials, including but not exclusively plastic materials, such as polycarbonates and polypropylene plastics, in whole or in part. In some embodiments, components of the growth chamber are composed of perfluorinated polymer optical fibers (Chromis Fiberoptics from Thorlabs Inc.) comprising graded-index plastic optical fibers (GI-POFs) realized by using an amorphous perfluorinated polymer, polyperfluorobutenylvinyl ether (commercially known as CYTOP®). These fibers have larger diameters than glass optical fibers, high numerical apertures, and good properties such as high mechanical flexibility, low cost, low weight, etc. The growth chamber 100 of FIG. 1A includes a solar concentrator 110, placed above the plant canopy of surrounding vines, having a cone shape, funnel shape, parabolic shape, a partial funnel shape, a partial cone shape a compound partial parabolic shape, while the chamber 100 of FIG. 1B includes a solar concentrator 110 having a partial cone shape, partial funnel shape, or partial parabolic shape. The solar concentrator comprises a reflective surface 211 and lower perimeter 225 configured for attachment to a light transmitter 120 at the upper perimeter 122. Positioned beneath the solar concentrator 110 is a light transmitter 120, which is tube shaped and includes openings 125. In some embodiments, the light transmitter 120 is configurable in two of more components 120a, 120b, along vertical edges 105 that can be held together with edge clamps 107. Alternatively, the vertical edges 105 that can be held together with edge clamps 107 along one edge and hinges 127 along an opposing edge. In the growth chamber shown in FIG. 1B, the openings 125 are arranged peripherally on the light transmitter. In some embodiments, the openings are arranged in pairs positioned laterally from one another to allow lateral airflow through the light transmitter. In some embodiments, the openings are positioned either randomly or systematically in a pattern, in numbers ranging from 1 to 20 about the periphery, and at variable heights relative to each other. The opening diameters have a functional range between 1.0 inch and 12.0 and need not all be the same diameter. In use, the openings allow for an operator to gain access to a growing plant or vine within, for example to prune or train or water or examine the plant or vine, and also allow airflow to cool or warm the plant, or to reduce humidity in the zone surrounding the plant. Airflow is important in some applications for preventing or limiting fungal growth within the zone surrounding the plant.

Positioned beneath the light transmitter 120 is a protective inner surface 140, configured to be positioned on the soil and engage the soil, over a growing plant or grape vine. In the embodiment depicted in FIGS. 1A, 1B, and 1D the protective inner surface 140 is conic or funnel-shaped, having an upper perimeter 505 for engaging the light transmitter, and a smaller lower perimeter 525 for engaging the soil surface surrounding the growing plant or grape vine, and has a rigid outer wall. The rigid outer wall is sufficiently rigid to protect the growing plant from growth limiting factors, such as wind damage, heat damage, cold damage, frost damage, snow damage, hail damage, herbicide damage, or animal damage. In the embodiment depicted in FIG. 1C the protective inner surface 140 is a short-stacked cylindrical shape, which optionally include openings 125, (not shown). Extending from the protective inner surface 140 are several legs 150 for supporting the growth chamber on the soil surface. Legs can have a variety of configurations, but generally all serve the same purpose of stabilization. In some embodiments, one or more of the legs 150 extend from the light transmitter 120.

In some embodiments, one or more of the legs 150 extend laterally to a distance greater than the diameter of the upper perimeter 505 of the protective inner surface and/or the diameter of the light transmitter to provide enhanced stability. Further still, in some embodiments, the legs further comprise one or more anchoring features (not shown) that support ground anchors (not shown) that can be driven into the soil to provide additional stability to the growth chamber. Alternatively, one or more anchoring features (not shown) are positionable around the periphery of the light transmitter 120 and/or the solar concentrator to provide anchoring points for stabilizing cables. Stabilizing features such as those previously described, or features serving a similar purpose, are particularly relevant in areas subject to high winds, rutting deer and/or ground tremors, for non-limiting example.

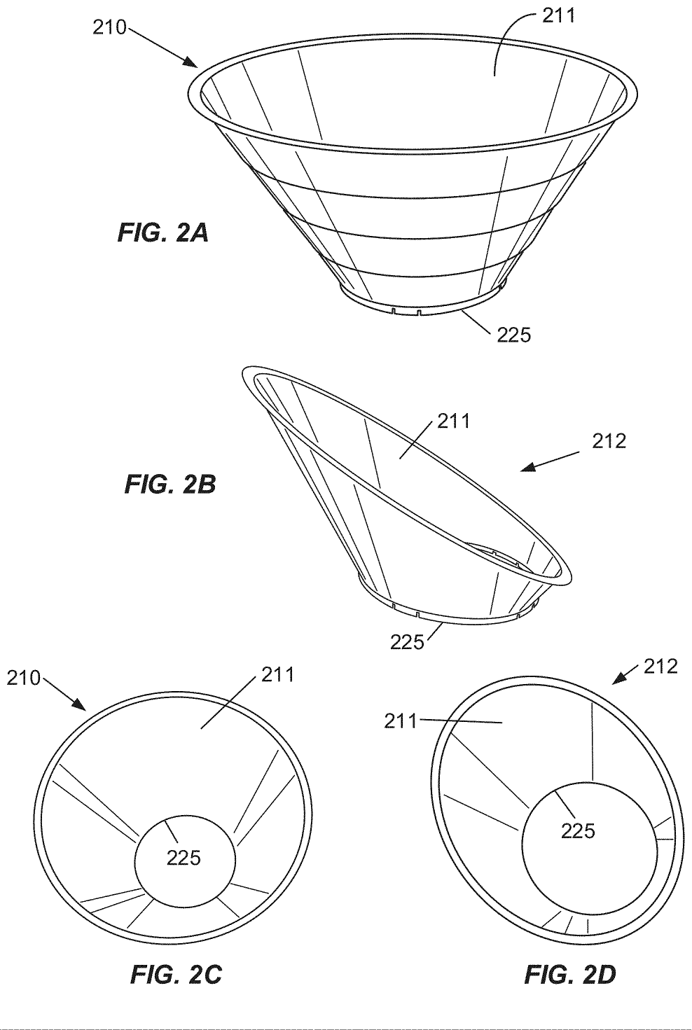

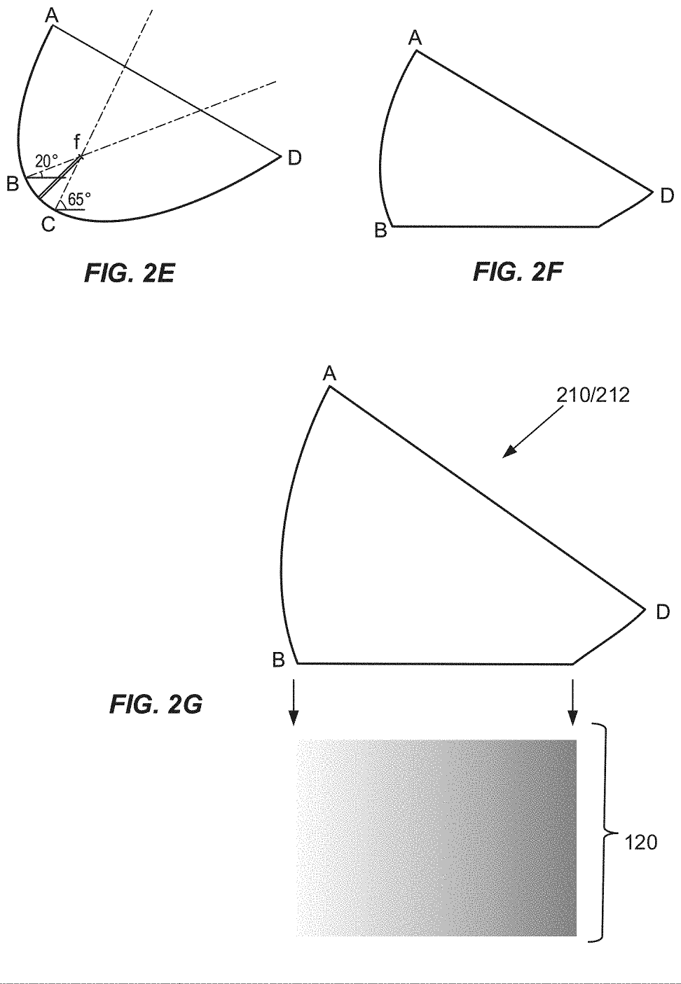

FIGS. 2A-2G depict non-limiting configurations of solar concentrators 210, 212, (110, 112), of growth chambers of the present disclosure in cone shapes (FIGS. 2A and 2C) and partial cone shapes (FIGS. 2B and 2D). FIG. 2E depicts an exemplary, non-limiting asymmetric-shaped, solar concentrator configuration. The illustrated asymmetric configuration comprises two parabolic curves, which are variably adjustable, combined to collect all light between selectable ranges of solar altitudes. As illustrated herein, a configuration such as the one illustrated is configured to collect all light incident between a solar altitude of about 20° and about 65°. FIG. 2F illustrates an exemplary truncated version of the non-limiting representation of the compound parabolic solar concentrator of FIG. 2D to configured to allow for attachment to a light transmitter of the exemplary growth chambers. FIG. 2G illustrates a representation of the attachment of the truncated parabolic solar concentrator to a light transmitter. The solar concentrators are configured such that, in use, solar energy is reflected from a solar-facing surface 211, concentrated, and directed into a light transmitter 120 in optical communication with the solar concentrator. The solar-facing surface 211, as depicted, is reflective in certain embodiments. Further, in some embodiments the solar-facing surface comprises a material that reflects yellow and/or red and far red light, is adapted to scatter or diffuse light, manipulate the spectral composition, or any combination of these, of the collected solar energy before the collected solar energy is directed to the light transmitter 120. In one preferred embodiment, the solar-facing surface is red in color. For example, the solar-facing surface 210 includes reflective material, such as buffed plastic, or a reflective coating, such as a metal coating, which comprises aluminum or silver, as non-limiting examples. Manipulation of the spectral composition includes reducing blue light, for example by absorbing blue light, enriching relative content of light in the yellow and/or red and/or far red spectral regions, reducing relative content of UV radiation, reducing relative content of UVB radiation, or any combination thereof.

Additionally, further manipulation of the spectral composition includes filtering out infrared (IR) radiation, (thermal radiation). Due to the potentially damaging effects of IR radiation, the inventors contemplate the selective addition of either IR filters, or heat absorbing filters designed to reflect or block mid-infrared wavelengths while passing visible light. In some embodiments, these filters are in the form of a filter sheet inserted across an aperture of the growth chamber, and/or as a coating on the inner reflective surfaces of the growth chamber components. Filters configured for blocking or reflecting the intermediate IR band, also called the mid-IR band, cover wavelengths ranging from 1,300 nm to 3,000 nm or 1.3 to 3.0 microns; Frequencies range from 20 THz to 215 THz.

Other examples of reflective coatings include but are not limited to Dielectric High Reflective (DHR) Coatings; Metallic High Reflective (MHR) Coatings; and Diode Pumped Laser Optics (DPLO) Coatings. DHR coating is designed to produce very high reflection (more than 99.8%) at designed wavelength. MHR coatings, commonly comprising Au, Ag, Al, Cr and Ni—Cr, have reflectivity lower than dielectric HR coatings, but their HR spectrum can be over near-UV, visible and near-IR. Diode Pumped Laser Optics (DPLO) coatings are commonly used for Nd-Laser applications.

As used herein, the preferred reflected light (or reflected solar energy) for stimulating growth is in the visible light range between yellow and far-red light. Alternatively, the preferred reflected light for stimulating growth is in the visible light range from about 5,400 Angstroms and about 7,000 Angstroms. Further, the preferred reflected light for stimulating growth comprises wavelengths from about 400-700 nm, about 570-750 nm and/or about 620-750 nm, and frequencies from about 508-526 THz and about 400-484 THz.

It is well known that plant development including growth, flowering and fruit production is dependent upon and is regulated by light energy. Solar radiation provides the energy for photosynthesis, the process by which atmospheric carbon is “fixed” into sugar molecules thereby providing the basic chemical building blocks for green plants as well as essentially all life on Earth. In addition, light is involved in the natural regulation of how and where the photosynthetic products are used within the plant and in the regulation of all photomorphogenetic and photoperiodic related processes. Plants can sense the quality (i.e., color), quantity and direction of light and use such information as signals to optimize their growth and development. This includes various “blue light” responses which depend on UVA and UVB ultraviolet wavelengths as well as traditional “blue” wavelengths. These regulatory processes involve the combined action of several photoreceptor systems, which are responsible for the detection of specific parts of the sunlight spectrum, including far-red (FR) and red (R) light, blue light, and ultra violet (UV) light. The activated photoreceptors initiate signal transduction pathways, which culminate in morphologic and developmental processes. The photosynthetically active radiation (PAR) ranges between 400-700 nm, because chlorophyll-protein complexes within the chloroplasts absorb the blue as well as the red part of the light spectrum. However, chlorophyll absorbs little of the green part of the spectrum which, of course, is why photosynthetic plants generally appear green in color.

Infrared (IR) waves lie between the visible light spectrum and microwaves. The closer the waves are to the microwave end of the spectrum, the more likely they are to be experienced as heat. Infrared waves can also affect how plants grow. According to at least one published Texas A&M study, infrared light plays a part in the blooming of flowering plants. Plants grown indoors grow well under fluorescent lights, but will not bloom until appropriate levels of infrared radiation have been introduced. Additionally, increased infrared waves can affect the speed at which plant stems grow. A short exposure to far infrared light increased the space between nodes when the exposure occurred at the end of an eight-hour light period. Exposing the plant to ordinary red light reversed this effect. A combination of far red and red light produced the longest internodes. Further still, too much infrared light, especially in the far red end of the spectrum, actually damages plants. Excessive heat discolors or kills plants, especially if those plants haven't recently been watered. Too much infrared light also causes plants to experience early growth spurts that reduce their health, or encourage them to flower too soon.

IR radiation extends from the nominal red edge of the visible spectrum at 700 nanometers (frequency 430 THz), to 1 millimeter (frequency 300 GHz). Infrared radiation is popularly known as “heat radiation”, but light and electromagnetic waves of any frequency will heat surfaces that absorb them. Infrared light from the Sun accounts for 49% of the heating of Earth, with the rest being caused by visible light that is absorbed then re-radiated at longer wavelengths. Objects at room temperature will emit radiation concentrated mostly in the 8 to 25 μm band, but this is not distinct from the emission of visible light by incandescent objects and ultraviolet by even hotter objects (re: black body and Wien's displacement law).

Heat is energy in transit that flows due to temperature difference. Unlike heat transmitted by thermal conduction or thermal convection, thermal radiation can propagate through a vacuum. Thermal radiation is characterized by a particular spectrum of many wavelengths that is associated with emission from an object, due to the vibration of its molecules at a given temperature. Thermal radiation can be emitted from objects at any wavelength, and at very high temperatures such radiations are associated with spectra far above the infrared, extending into visible, ultraviolet, and even X-ray regions (e.g. the solar corona). Thus, the popular association of infrared radiation with thermal radiation is only a coincidence based on typical (comparatively low) temperatures often found near the surface of planet Earth.

Generally, low-to-medium light intensities are sufficient to drive photomorphogenetic and photoperiodic processes, while for photosynthesis the total amount of sunlight energy is a major factor dictating plant productivity.

Plant pests (largely insects and arachnids) as well as fungal and bacterial diseases are also known to respond to the intensity, spectral quality and direction of sunlight. They mostly respond to the ultraviolet (UVA and UVB), blue and yellow spectral regions. Thus, pest and disease control might be achieved by light quality and quantity manipulations. Additionally, it is also well known that blue light will slow growth down and induce dwarfing, which is opposite the desired effect in this case.

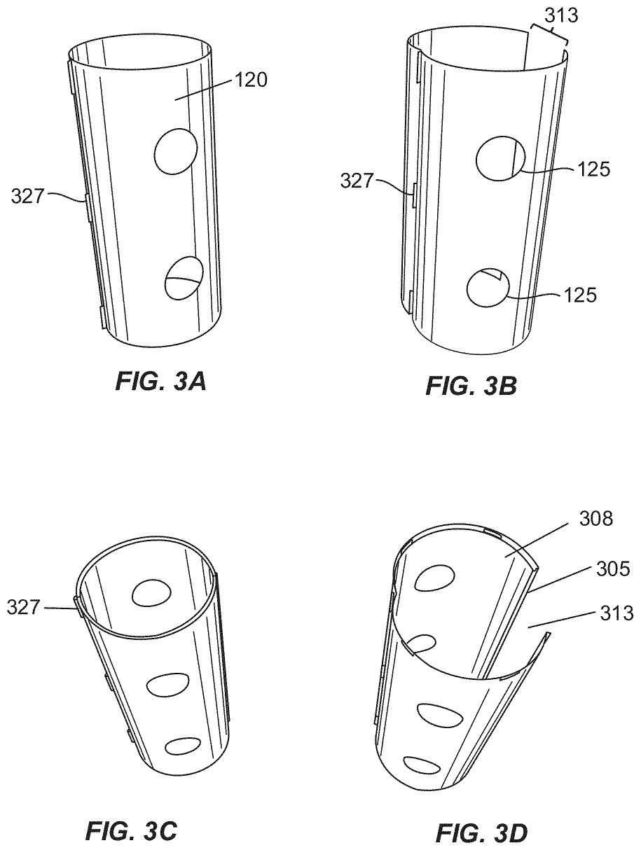

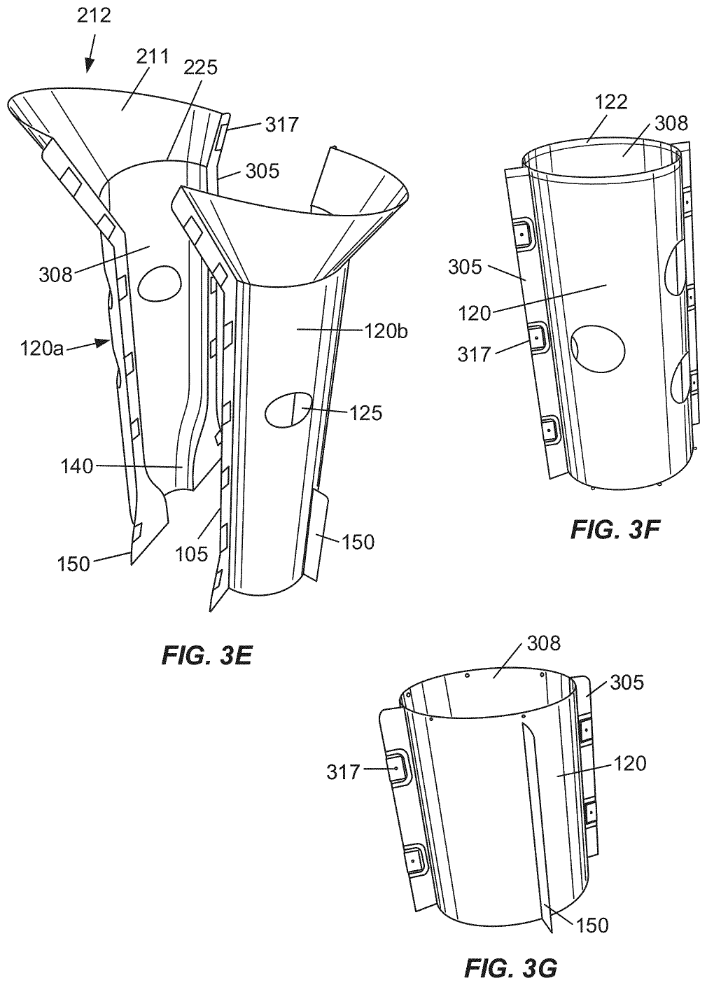

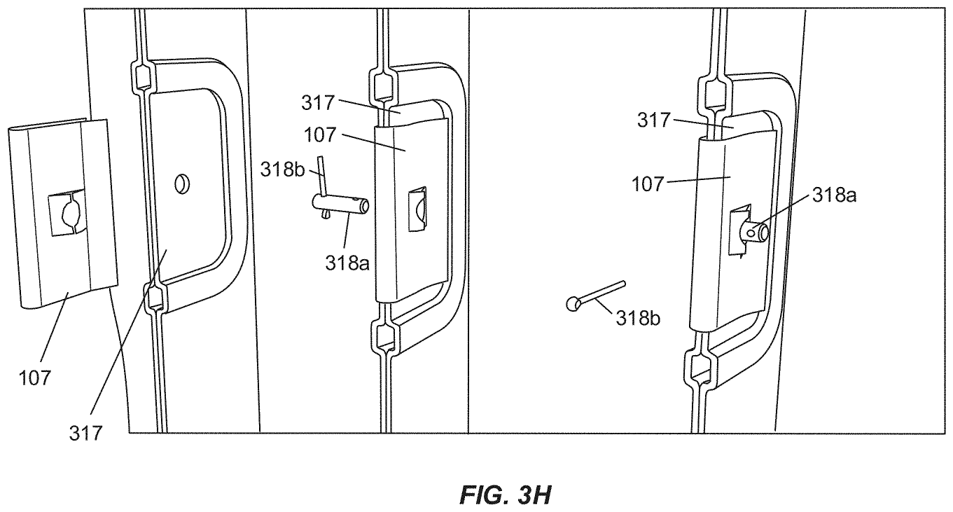

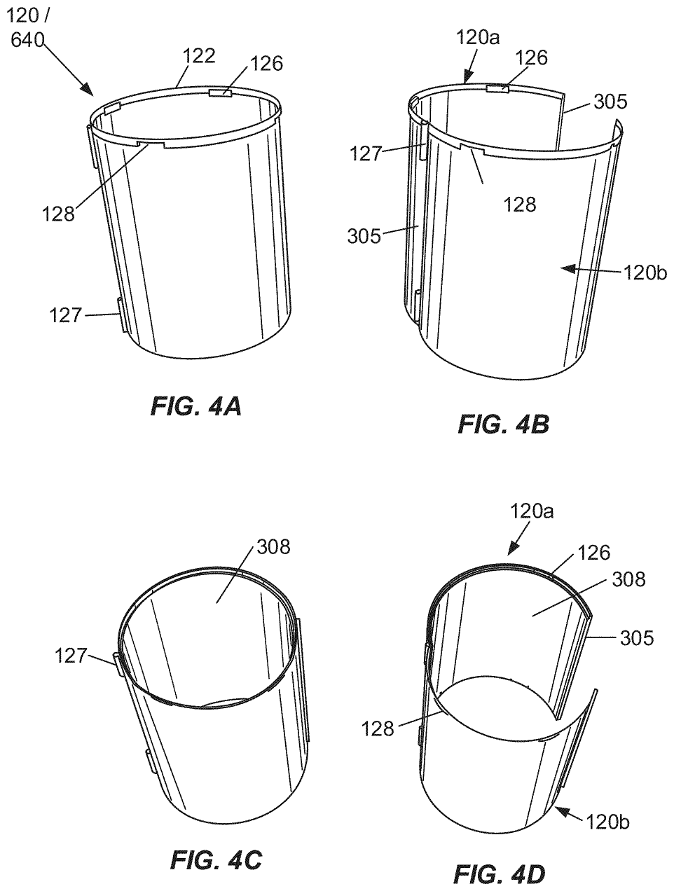

FIGS. 3A-3G and 4A-4D depict exemplary light transmitters 120 and/or light transmitter bases 640 of the growth chambers of the present disclosure in closed positions (FIGS. 2A and 2C; 4A and 4C) and open positions (FIGS. 2B and 2D; 4B and 4D). The depicted light transmitters are opened along a vertical opening 313 by flexing of a hinge element 327, or by breaking the light transmitter 120 open along two vertical openings 305, which comprises interlocking or fastening elements 107, 307, 317 for holding the light transmitter in a closed position. All openings discussed herein, in certain embodiments, are fastened in a closed positioner by fasteners, as depicted in FIGS. 3E-3H, wherein the growth chamber is configured from halved components, assembled along the vertical edges 305 with clamps 107 at appropriate clamp joints 317. By opening the light transmitters to expose the inner surface 308, an operator easily installs or de-installs the growth chamber including the light transmitter, and more easily gains access to a contained plant, or allows for increased airflow and/or heat dissipation to and from the external environment into or out of a protected zone including the plant. The light transmitters 120 are configured such that, in use, solar energy is reflected from the solar-facing surface 210, concentrated, and directed through the light transmitter 120, which is in optical communication with the solar concentrator 110, and toward the growing plant contained within the growth chamber. The growing plant is contained within a protective inner surface located below the light transmitter 120. The inner wall 308 of the light transmitter 120, as depicted, is reflective in certain embodiments. In a preferred embodiment, the inner wall surface is red in color. Further, the inner wall 308 may comprise a material that reflects light, is adapted to scatter or diffuse light, manipulate the spectral composition, or any combination of these, of the collected solar energy before the collected solar energy is directed toward the growing plant which is contained within a protective inner surface located below the light transmitter 120. For example, the inner wall 210 includes reflective material, such as buffed/polished plastic, or a reflective coating, such as a metal coating, which, in some embodiments, comprises aluminum or silver, as non-limiting examples. Other common coatings include Dielectric High Reflective (DHR) coatings or Metallic High Reflective (MHR) coatings. Manipulation of the spectral composition includes reducing blue light, for example by absorbing blue light, enriching relative content of light in the yellow and/or red and far-red spectral regions or their combination, reducing relative content of UV radiation, reducing relative content of UVB radiation, or any combination thereof.

In some embodiments, an interface between the concentrator and the light transmitter is a fixed connection. In some embodiments, an interface between the concentrator and the light transmitter is a hinged connection. In some embodiments, an interface between the concentrator and the light transmitter is a rotary or swivel connection capable of swiveling up to 360 degrees so that the concentrator can easily be turned to best follow the path of the sun. In some embodiments, the interface between the concentrator and the light transmitter comprising a rotary connection capable of swiveling will further comprise a sunlight tracking system such as an imaging optical system. In some embodiments, the concentrator geometry possesses a large acceptance angle or numerical aperture meaning that a fixed unit can effectively collect sunlight over a wide range of angles of incidence as the sun processes overhead during the course of the day. A typical concentrator with a 45 degree acceptance angle will be able to effectively collect sunlight for 6-8 hours; hence an active tracking subsystem is not required, reducing system complexity and cost.

In some embodiments, the growth chamber comprises interlocking or fastening elements at the interface between the concentrator and the light transmitter for holding the concentrator in a fixed position relative to the light transmitter.

The growth chambers of the present disclosure are designed with appropriate hinges, hooks, holes, and height adjustments so that they can easily be installed and secured to the trellis, or alternately, easily be removed and reinstalled at the next site or stored for future use. For best results, tests have shown that the growth chambers of the present disclosure produce the best results when put in place before the newly planted vine begins to grow in the spring.

The growth chambers of the present disclosure are removed after the first season of growth, sometime after shoot growth reaches the top of the stake. An exception would be if vines were planted late in the season and shoot growth did not reach the top of the stake. In that case, the growth chambers would remain in the field for a second year, and the top of the collector and side holes would be capped or covered with a transparent cover during the winter months to protect from frost damage, snow damage, and hail damage, yet allow for solar light and heat penetration.

The growth chambers of the present disclosure help protect the vine during episodes of severe winter cold. When temperatures drop below 22° F., buds can be damaged even on mature wood. It is thus recommend that the growth chambers not be removed until late January, at least in California, after which it is unlikely that a severe cold episode will occur in California. Recommendations for alternative northern climates such as New York, as a non-limiting example would likely extend further into the late-winter and early spring months of the new growing season.

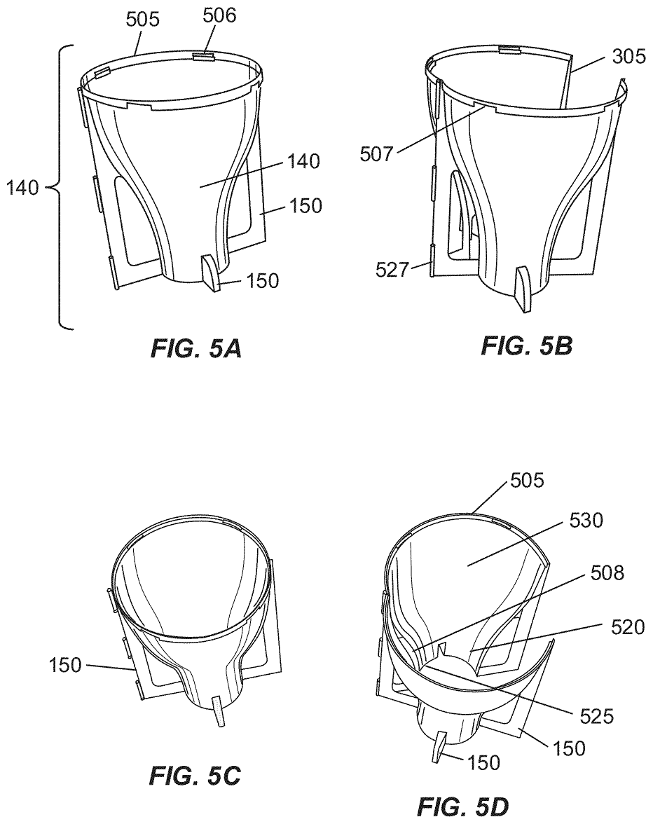

FIGS. 5A-5D depict exemplary protective inner surfaces 140 of the growth chambers of the present disclosure in closed positions (FIGS. 2A and 2C; 4A and 4C) and open positions (FIGS. 2B and 2D; 4B and 4D). The depicted protective inner surfaces are opened along a vertical opening 510 by flexing of a hinge element (not shown), such as those described and depicted previously for the light transmitters, or by breaking the protective inner surface 140 open along two vertical openings 510, which comprises interlocking or fastening elements for holding the protective inner surface in a closed position. All openings discussed herein, in certain embodiments, are fastened in a closed positioner by fasteners. The protective inner surfaces depicted are funnel-shaped, and define a protected zone 520 which, in use, will surround or contain a growing plant or grape vine replant. By opening the protective inner surface, an operator will easily install or de-install the growth chamber including the protective inner surface, will more easily gain access to a contained plant, or will allow for increased airflow and/or heat dissipation to and from the external environment into a protected zone including the plant. The protective sleeves 140 are configured such that, in use, solar energy is received from the light transmitter 120, optionally reflected from an inner surface 530 of the protective inner surface, and directed through the light transmitter 120, which is in optical communication with the inner portion of the protective inner surface 140, and toward the growing plant contained within the growth chamber, in some embodiments specifically within the protected zone 520. In a preferred embodiment, the inner surface is red in color. The inner surface 530 comprises a material that reflects light, is adapted to scatter or diffuse light, manipulate the spectral composition, or any combination of these, of the collected solar energy before the collected solar energy is directed toward the growing plant which is contained within a the protected zone 520. For example, the inner surface 530 includes reflective material, such as buffed plastic, or a reflective coating, such as a metal coating, which, in some embodiments comprises aluminum or silver, as non-limiting examples. Other common coatings include Dielectric High Reflective (DHR) coatings or Metallic High Reflective (MHR) coatings. Manipulation of the spectral composition includes reducing blue light, for example by absorbing blue light, enriching relative content of light in the yellow or red or far-red spectral regions, reducing relative content of UV radiation, reducing relative content of UVB radiation, or any combination thereof. In the embodiments depicted in FIGS. 5A-5D, the protective inner surface 140 is funnel-shaped, having an upper perimeter 505 for engaging the light transmitter, and a smaller lower perimeter 525 for engaging the soil surface surrounding the growing plant or grape vine, and has a rigid outer wall. The rigid outer wall is sufficiently rigid to protect the growing plant from growth limiting factors, such as wind damage, heat damage, cold damage, frost damage, herbicide damage, or animal damage.

Extending from the protective inner surface 140 are several legs 150 for supporting the growth chamber on the soil surface. In some embodiments, one or more of the legs 150 extend from the light transmitter 120.

In some embodiments, one or more of the legs 150 extend laterally to a distance that is greater than the diameter of the upper perimeter of the protective inner surface and/or the diameter of the light transmitter to provide enhanced stability. Further still, in some embodiments, the legs further comprise one or more anchoring features (not shown) that support ground anchors (not shown) that can be driven into the soil to provide additional stability to the growth chamber. Alternatively, one or more anchoring features (not shown) are positionable around the periphery of the light transmitter 120 and/or the solar concentrator to provide anchoring points for stabilizing cables. Stabilizing features such as those previously described, or features serving a similar purpose, are particularly relevant in areas subject to high winds and/or ground tremors, for non-limiting example.

### Uses of the Growth Chambers of the Present Disclosure in Stimulating Growing Grape Vine or Grape Vine Replant Growing Conditions

Growth chambers of the present disclosure are useful in improving the growth rate of plants. In some embodiments, growth chambers of the present disclosure are useful in improving the growth rate of newly planted grape vines or grape vine replants, for example in the vineyard setting. An exemplary use of growth chambers of the present disclosure is during the first two years of vine development, where the presently disclosed growth chambers are useful to reduce the time required to bring a new vineyard into full production and/or to reduce the time required for a replanted vine in an existing vineyard to achieve full production.

Growth chambers of the present disclosure are useful in vineyards located in cool climate regions, (i.e. Napa, Sonoma, Mendocino, Santa Clara, Monterey, and Santa Barbara, Calif.). Using Cabernet Sauvignon as an example, vineyard establishment begins with planting the new vines and allowing them to grow freely that year without training. The second year a single shoot is selected and trained up the stake. A small crop is produced the third year after planting, and then annual yields increase until full production is achieved on the sixth year. The typical yield sequence during the six year period is 0, 0, 1, 3, 4, 5 tons per acre for a total of 13 tons for the period. Cabernet is a vigorous variety and establishment takes longer for less vigorous cultivars such as Chardonnay or Pinot Noir.

For comparison, in hot climate viticulture areas (i.e. Sacramento Valley, San Joaquin Valley, Coachella and Riverside County) vines are planted and then trained up the stake the same year. A small yield is harvested the following year. The typical yield sequence, using Cabernet Sauvignon as an example, is 0, 5, and 15 tons per acre with full production achieved after three years. Among the reasons for the huge difference comparing cool and hot climates is solar radiation, heat units, and less wind damage.

Growth chambers of the present disclosure are used to enhance solar radiation and heat in a protected zone in the immediate vicinity of the growing plant or growing grape vine or grape vine replant, and protect the vine from wind; thereby, accelerating the growth of the vine the first two years of establishment. Gains in growth during the first two years will shorten time required to reach full production, as much as a year or more.

Growth chambers of the present disclosure further comprise placement of a heat sink 600 in one or both of the light transmitter 120 and the protective inner surface 140, for gathering the concentrated solar heat energy in the heat sink at one time, such as during the peak sunlight hours of the day, and gradually releasing the gathered solar heat energy into the protected zone at a later time, such as late in the evening or early morning hours when nighttime temperatures could dip to dangerously low levels.

As used herein, a heat sink is typically a “passive” heat sink which collects and stores radiated heat, thus reducing the surrounding ambient temperature in the growth chamber during midday and early afternoon, and increasing the ambient temperature in the growth chamber late in the afternoon and early evening hours. The ideal material is: 1) dense and heavy, so it can absorb and store significant amounts of heat (lighter materials, such as wood, absorb less heat); 2) a reasonably good heat conductor (heat has to be able to flow in and out); and 3) has a dark surface, a textured surface or both (helping it absorb and re-radiate heat). Different thermal mass materials absorb varying amounts of heat, and take longer (or shorter) to absorb and re-radiate it.

Materials commonly preferred and used for heatsinks described herein commonly comprise: concrete, copper and/or aluminum, but commonly include other materials, such as those known by one of skill in the art.

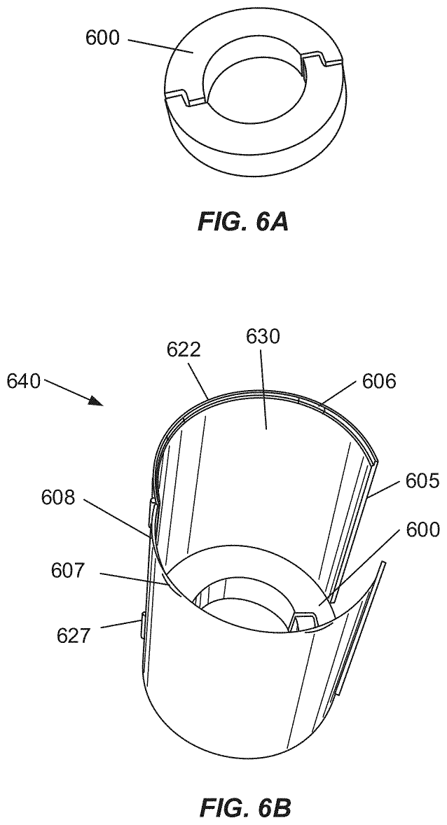

As illustrated in FIGS. 6A & 6B, the heat sink 600 is circular in shape defining an opening for surrounding the growing grape vine or grape vine replant. However one of skill in the art would recognize that the heat sink could have any exterior shape that would fit within one or both of the light transmitter 120 and the protective inner surface 140 having an opening for surrounding the growing grape vine or grape vine replant.

The heat sink 600, as described herein comprises one circular portion or two or more partial circular portions that engage one another to form the circular shape. However, as noted above, one of skill in the art would recognize that the heat sink could have any exterior shape that would fit within one or both of the light transmitter 120 and the protective inner surface 140 having an opening for surrounding the growing grape vine or grape vine replant.

The potential financial gain from advancing grape vine development is significant. Cabernet Sauvignon in California's cool climate regions was valued at $7,000 per ton in 2016. Growth chambers of the present disclosure will advance yield dynamics during the first six years from 0, 0, 1, 3, 4, 5 to 0, 1, 3, 4, 5, 5 (tons per acre per year). Total yield during the six year period would be 13 vs. 18 tons per acre, and with a crop valued at $7,000 per ton, this is a significant financial incentive.

There are additional potential advantages to using the growth chambers of the present disclosure. In use, the disclosed growth chambers enclose vines within a tube, which comprise a protective inner surface and/or a light transmitter, and in some embodiments the tube (light transmitter) of the growth chamber extends three to four feet above the ground surface. (i) In some embodiments, the tube protects the growing plants or grape vines from rabbits, deer, and other vertebrate pests. (ii) In some embodiments, the outer surface of the tube repels insect pests and therefore reduce pesticide applications on the growing plants or grape vines. (iii) In some embodiments, it allows herbicides to be sprayed down the vine row without contacting and harming young, susceptible vine tissue. (iv) In some embodiments, it provides protection from wind, which otherwise reduces growth and is a significant problem in Monterey County and other cool climate regions. (v) In some embodiments, it will provide frost protection which is an issue in all viticulture regions. (vi) Finally, in some embodiments, growth chambers of the present disclosure will act as a means of training vines reducing the amount of hand labor required to train the shoot that will become the trunk.

It should also be noted that in any one of the embodiments described herein, the use of the growth chamber can also result in water conservation and savings in irrigation costs. For example, in addition to the benefits described above, with a newly planted vineyard, the growth chamber also acts a wind break, which leads to less evapotranspiration by the plants and thus water (irrigation) saving.

### EXAMPLE 1

### Replanting Vines in Mature Vineyards, San Joaquin Valley

If it were not for dead arm or wood rot diseases (Botryosphaeria and Eutypa), some vineyards in California could remain productive for fifty years or more. Unfortunately, once a vineyard is older than fifteen years of age the scourge of dead arm disease begins to take its toll with many vines in the vineyard becoming unproductive because of dead or dying trunk wood. These vines need to be replaced and the rate of replacement may be 1% in the early years but rise to 5% as the vineyard ages past twenty. If replacement is deferred, a vineyard in California, cool or hot climate, rarely remains productive past twenty years, and will need to be removed.

A common practice in the San Joaquin Valley and other places, in older vineyards is to plant a new vine on rootstock next to the vine in decline, typically towards March. The weakened vine is either removed immediately or cropped another year or two before removal. The newly planted vine grows rapidly until the end of May at which point it becomes over-shaded by the vineyard canopy. Because of shading, growth during the remainder of the season is limited. It takes more than twice as long to establish the vine because of shading.

Growth chambers of the present disclosure are be used to illuminate the young vine so that growth is equal to or faster than that of a young vine developing under full light, and to warm the vine during February-April. Excess heat could be a problem in the San Joaquin Valley during the major growth season (May-October). Growth chambers of the present disclosure dissipate heat while transmitting the desired amounts of sunlight to the newly planted young vine. Other potential functions of growth chambers of the present disclosure include vine training, protection form herbicide sprays, and frost protection.

A conservative estimate is that 100,000 acres of vineyards in California are older than 15 years of age and each year at least 10 replant vines per acre may be required to sustain the productivity of these older vineyards.

### EXAMPLE 2

### Replanting Vines in Mature Vineyards, Cool Climate Regions

Just as in the San Joaquin Valley, replanting vines in older vineyards may be important also in cool climates. Without a replant program, the production of 20 year old vineyard may be 50% of what the vineyard yielded in its prime. Growth chambers of the present disclosure will also be used for establishing new vineyards and will also be used for replants in mature vineyards.

The primary design difference for cool and hot climate application is heat. Increasing temperature may be desirable in cool climate but may be injurious to plants growing in hot climates.

### Photoselectivity

Plant development depends not only on light quantity, but also on light quality. In addition to being the energy source for photosynthesis, light also acts as a signal of the environmental conditions surrounding the plants. Plants contain photoreceptor pigments, which capture energy in different regions of the electromagnetic spectrum and function as signal transducers to provide information on the surrounding environment. These signals are further translated into physiological and morphological adaptations of the plant.

Manipulations of the spectral composition of the intercepted sunlight can affect numerous traits of plant development, such as the rate of growth, canopy structure, flowering, fruit-set, water-use-efficiency, and plant coping with biotic and abiotic stresses. For example, reducing of the content of blue light, while enriching the relative content of the yellow and red spectral regions, will stimulate the vegetative growth and overall plant vigor.

Light scattering is another manipulation that can provide additional benefits for plant growth and agricultural crop development and productivity.

On the other hand, ultraviolet (UV) radiation, particularly UVB wavelengths, might have detrimental effects on plant physiology, leading to growth inhibition. The UV component is also involved in stress-signaling in plants, as well as plant insect-pests and diseases.

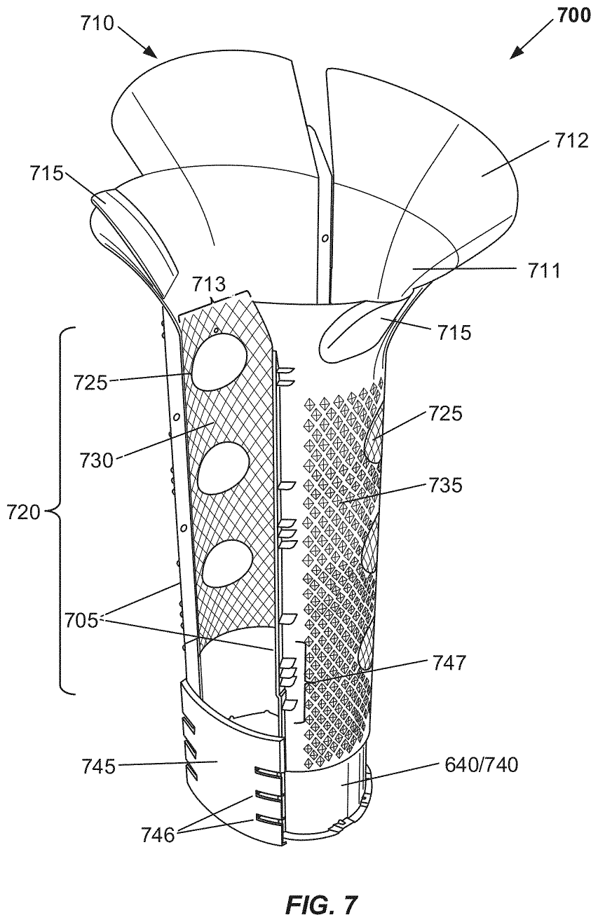

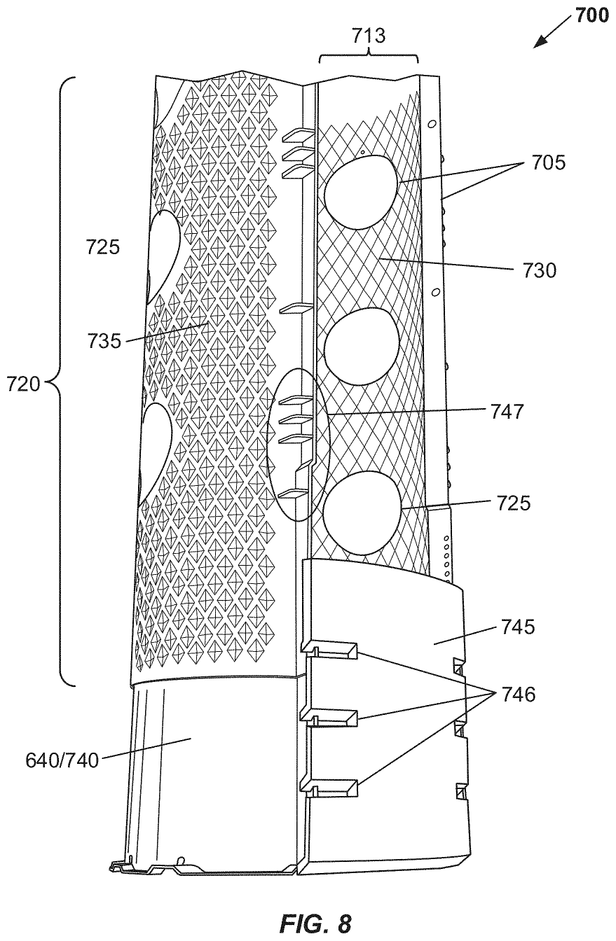

Noting the previous observations, and referring now to FIG. 7, in some embodiments of the growth chamber, both the interior and exterior main walls of the downtube feature a textured pattern. This textured pattern enhances the scattering within the tube to more evenly distribute the light. It also helps to avoid the creation of localized focal ‘hotspots’ within the tube that can potentially cause damage. In some embodiments, the shapes are small pyramids. In some embodiments, other ‘squircle’ shapes, (shapes having a semi-rectangular and semi-circular configuration), have been utilized to further optimize the design and effects.

The downtube is also textured on the exterior walls; this texture following the interior pattern to minimize the volume of plastic required for the structure. However it's also great at scattering and homogenizing light that falls on the exterior of the unit and thus can be beneficial in delivering light to neighboring plants and have an equally effective benefit in pest control, as noted in the literature below. In summary, the textured interior and exterior walls of the downtube act to scatter/homogenize/diffuse light within and around the device generating benefits to the overall health of the plant(s) that they surround and reside adjacent to.

The spectrum of colors visible to insects is shorter in wavelength, relative to humans. Insects have photoreceptors that can sense the UVB, blue and green-yellow, but not red).

Spectral manipulation of light is a relatively new tool for insect pest control. Covering crops by photoselective netting materials is one such tool. It has been found that yellow and pearl netting (but not their equivalent black or red netting) can reduce insect-pest infestation (e.g. white flies and aphids) and their viral-borne diseases. Although the end result is similar for both yellow and pearl photoselective netting materials, their mechanism of action is different. See abstracts below.

For example, as noted in: Ben-Yakir, D. Antignus, Y., Offir, Y. and Shahak, Y. (2012) Optical Manipulations: An Advance Approach for Controlling Sucking Insect Pests. In: Advanced Technologies for Managing Insect Pests (Isaac Ishaaya, Suba Reddy Palli, Rami Horowitz, eds.) Springer Science+Business Media Dordrecht, pp. 249-267: “Aphids and white flies have light receptors in the ultraviolet (UV) region with peak sensitivity at 330-340 nm and in the green-yellow region with peak sensitivity at 520-530 nm (Doring and Chittka, 2007; Coombe, 1981, 1982; Mellor et al., 1997). Using the electroretinogram technique, Kirchner et al. (2005) noted that alate female summer-migrants of the aphid, M. persicae, have additional photoreceptor in the blue-green region (490 nm). Aphid color vision is achieved by possessing two to three classes of spectral receptors that either elicit direct response or are used in an opponent mechanism to ‘compare’ inputs from different spectral domains; (Doring and Chittka, 2007 and references therein). Thrips have light receptors in the yellow region (540-570 nm), the blue region (440-450 nm) and the UV region (350-360 nm) (Vernon and Gillespie 1990). Aphids and whiteflies do not possess receptors for red light (610-700 nm) and therefore their response to red is either neutral (Mellor et al., 1997) or inhibitory (Vaishampayan et al. 1975). However, alate green spruce aphids, Elatobium abietinum (Walker), were caught on red sticky traps more than on yellow or white traps (Straw et al., 2011), and females of the common blossom thrips, Frankliniella schultzei, are attracted to red flowers and to red traps (Yaku et al. 2007)”.

In another article; Ben-Yakir, D., Antignus, Y., Offir, Y. and Shahak, Y. (2012) Optical manipulation of insect pests for protecting agricultural crops. Acta Hortic. 956: 609-616; the authors note that sucking insect pests, such as aphids, whiteflies and thrips, cause great economic losses for growers of agricultural crops worldwide. These pests inflict direct feeding damages and they often transmit pathogenic viruses to crop plants. These pests use reflected sunlight as optical cues for host finding. The optical properties, size, shape, and contrast of the color cue greatly affect the response of these pests. Therefore, manipulation of optical cues can reduce the success of their host findings. These pests are known to have receptors for UV light (peak sensitivity at 360 nm) and for green-yellow light (peak sensitivity at 520-540 nm). Green-yellow color induces landing and favors settling (arresting) of these pests. High level of reflected sunlight (glare) deters landing of these insects. The authors have proposed the use of optical cues to divert pests away from crop plants. This can be achieved by repelling, attracting and camouflaging optical cues. The manipulating optical additives can be incorporated to mulches (below plants), to cladding materials (plastic sheets, nets and screens above plants) or to other objects in the vicinity of the plants. Cladding materials should contain selective additives that let most of the photosynthetically active radiation (PAR) pass through and reflect the wavelengths that sucking pest perceive. Results of these studies indicate that optical manipulation can reduce the infestation levels of sucking pests and the incidences of viral diseases they transmit by 2-10 fold. Delay of the aphids infected with non-persistent viruses that must be transmitted within minutes to 1-2 hours, by arresting colors, is expected to reduce the efficacy of viral transmission. This technology can be made compatible with the requirements for plant production and biological control. Optical manipulations can become a part of integrated pest management programs for both open field and protected crops.

There are two major mechanisms that occur which were not previously explained or fully understood. (1) Yellow surfaces attract the insect pests; they land on that surface, get “confused”, and either die while “thinking” what to do, or fly away if they still have energy. In addition, leaves of plants exposed to yellow (or red for this matter) do not look the same to the sucking pests, since the spectrum of reflection differs from their reflection of natural light. So they might not recognize the leaves, once inside the scattered yellow light environment. (2) Repellence/deterrence by surfaces that are either highly reflective (e.g. shiny aluminum) or reflect light which is poor in UV (required for navigation), or polarized in a way that they tend to avoid. Both mechanisms are potentially useful for this concept of growth chamber; especially if they are applied on the outer surfaces.

Optical manipulation is an environment-friendly tool in integrated pest management (IPM) that is reducing the need for pesticide chemicals. So far it is not fully replacing the chemicals, but is likely to happen in the future.

In anticipation of widespread future adoption, in some embodiments, the growth chamber units of the present disclosure have been configured such that they are red inside for maximal plant growth stimulation, while having the following colors outside as pest-control aids with noted effects as follows:

Yellow (Arresting mechanism: insects are attracted to the yellow surface, land outside the units and die thereabout);

Pearl-white (Avoidance mechanism: insects are deterred from flying towards surface that reflects light that is poor in its UV content); and

Highly reflective metallic: (As noted previously, when used alone or combined with other affects (e.g. polarization, UV), is effective in influencing the behavior of a great number of arthropods of interest).

Further, in some embodiments, an external coating has been added onto the growth chamber units of the present disclosure comprising reflective polarization materials (nano-particle coating, or materials like those used in polarized sun-glasses, car coating, or otherwise) to confuse/disorient/detract arthropod pests (flies, beetles, ants, locusts etc.), or to attract pollinating insects. The spectrum of the reflective polarization coating (UV, blue, green, yellow, red) can be chosen according known behavior of the arthropod of main interest.

Insects have polarization vision and can thus respond to light reflection-polarization from various reflective objects, e.g. water bodies, cars, plants etc.

As used herein, polarization vision is the ability of animals to detect the oscillation plane of the electric field vector of light (E-vector) and use it for behavioral responses. This ability is widespread across animal taxa but is particularly prominent within invertebrates, especially arthropods.

It is further noted in: Ben-Yakir, D., Antignus, Y., Offir, Y. and Shahak, Y. 2012. Optical manipulation of insect pests for protecting agricultural crops. Acta Hortic. 956:609-616: “Sucking insect pests, such as aphids, whiteflies, and thrips, cause great economic losses for growers of agricultural crops worldwide. These pests inflict direct feeding damages and they often transmit pathogenic viruses to crop plants. These pests use reflected sunlight as optical cues for host finding. The optical properties, size, shape, and contrast of the color cue greatly affect the response of these pests. Therefore, manipulation of optical cues can reduce the success of their host findings. These pests are known to have receptors for UV light (peak sensitivity at 360 nm) and for green-yellow light (peak sensitivity at 520-540 nm). Green-yellow color induces landing and favors settling (arresting) of these pests. High levels of reflected sunlight (glare) deters landing of these insects.

In some embodiments, the growth chamber units of the present disclosure use optical cues to divert pests away from crop plants. This can be achieved by repelling, attracting and camouflaging optical cues. The manipulating optical additives will also be incorporated into mulches (below plants), into cladding materials (plastic sheets, nets and screens above plants) and/or into other objects in the vicinity of the plants. Cladding materials will contain selective additives that let most of the photosynthetically active radiation (PAR) pass through and reflect the wavelengths that sucking pest perceive. Results of studies conducted by the inventors herein, indicate that optical manipulation can reduce the infestation levels of sucking pests and the incidences of viral diseases they transmit by 2-10 fold. Delay of the aphids infected with non-persistent viruses that must be transmitted within minutes to 1-2 hours by arresting colors is expected to reduce the efficacy of viral transmission. This technology has now been made compatible with the requirements for plant production and biological control. Optical manipulations have become an integral part of the integrated pest management programs for both open field and protected crops utilizing the growth chamber units of the present disclosure.

As further noted in: Ben-Yakir, D. and Fereres, A. (2016): The Effects of UV Radiation On Arthropods: A Review Of Recent Publications (2010-2015). Acta Hortic.; 1134, 335-342 DOI: 10.17660/ActaHortic.2016.1134.44 https://doi.org/10.17660/ActaHortic.2016.1134.44: “Insects and mites use optical cues for finding host plants and for orientation during flight. These arthropods often use UV radiation as the cue for taking-off and for orientation. Growing crop plants without UV often leads to low pest infestation, slow dispersal of pests and low incidences of insect borne diseases. Therefore, covering crops with plastics or screens containing UV-blocking additives provides protection from pests and diseases compared to standard cladding materials. The attraction of insects to host plants and to monitoring traps is enhanced by moderate UV reflection. In contrast, high UV reflection (over 25%) acts as a deterrent for most arthropods. Direct exposure of arthropods to UV often elicits stress responses and it is damaging or lethal to some life stages. Therefore, direct exposure of arthropods to UV often induces an avoidance behavior and this is why they often reside on the abaxial side of leaves or inside plant apices as a means to avoid solar UV. Solar UV often elicits stress response in host plants, which indirectly may reduce infestation by certain arthropod pests. Jasmonate signaling plays a central role in the mechanisms by which solar UV increases resistance to insect herbivores in the field. Jasmonate (JA) and its derivatives are lipid-based plant hormones that regulate a wide range of processes in plants, ranging from growth and photosynthesis to reproductive development. In particular, JAs are critical for plant defense against herbivory and plant responses to poor environmental conditions and other kinds of abiotic and biotic challenges.

Thus, UV radiation affects agroecosystems by complex interactions between several trophic levels. A summary of recent publications is presented and discussed herein.
N. Shashar, S. Sabbah and N. Aharoni (2015) Migrating locusts can detect polarized reflections to avoid flying over the sea. Biology Letters 1, 472-475; where the authors disclose that the desert locust Schistocerca gregaria is a well-known migrating insect, travelling long distances in swarms containing millions of individuals. During November 2004, such a locust swarm reached the northern coast of the Gulf of Aqaba, coming from the Sinai desert towards the southeast. Upon reaching the coast, they avoided flying over the water, and instead flew north along the coast. Only after passing the tip of the gulf did they turn east again. Experiments with tethered locusts showed that they avoided flying over a light-reflecting mirror, and when given a choice of a non-polarizing reflecting surface and a surface that reflected linearly polarized light, they preferred to fly over the former. Our results suggest that locusts can detect the polarized reflections of bodies of water and avoid crossing them; at least when flying at low altitudes, they can therefore avoid flying over these dangerous areas.
https://www.polarization.com/eyes/eyes.html; Insect P-Ray Vision: The Secret in the Eye; wherein the author discloses humans have some marginal sensitivity to polarized light as discovered by Haidinger in 1846 (naked-eye) but it was not until the late 1940's that researchers realized that many animals can “see” and use the polarization of light. This extra dimension of reality remains mostly invisible to humans without the aid of instruments but it is of vital importance to a host of animals. After the dance of honeybees tipped-off Frisch about their gift, other researchers went looking for polarized-vision (P-vision) elsewhere and found it in an extraordinary range of animals, including fish, amphibians, arthropods and octopuses. These animals use it not only as a compass for navigation, but also to detect water surfaces, to enhance visual power (similar to colors), and perhaps even to communicate. We now know that the eyes of many invertebrates have a structure that lends itself for sensitivity to polarized light. So much so, that evolution has taken specific steps to limit this sensitivity and not overwhelm and confuse the sensorial processors. On the other hand, the eyes of most vertebrates are not well suited for the detection of polarization. Reports of this ability in higher vertebrates were often wrong. For example, homing pigeons were thought from the late seventies to early nineties to possess that capacity, only to be disproved by more careful experiments. But we are still far from knowing the full extent of polarization vision in the animal kingdom and its fusion with standard vision. It remains an active and exciting field of research where amateur scientists can still make significant contributions.
R. Wehner, (1976) Polarized-light navigation by insects. Scientific American, Vol. 23 (1), pp. 106-115, 1976; wherein the author has disclosed that experiments demonstrate that bees and ants find their way home by the polarization of the light of the sky. The detection system insects have evolved for the purpose is remarkably sophisticated.
http://rspb.royalsocietypublishing.org/content/273/1594/1667.short; Why do red and dark-coloured cars lure aquatic insects? The attraction of water insects to car paintwork explained by reflection-polarization signals: György Kriska, Zoltán Csabai, Pál Boda, Péter Malik, Gábor Horváth; wherein the authors disclose the visual ecological reasons for the phenomenon that aquatic insects often land on red, black and dark-coloured cars. Monitoring the numbers of aquatic beetles and bugs attracted to shiny black, white, red and yellow horizontal plastic sheets, they found that red and black reflectors are equally highly attractive to water insects, while yellow and white reflectors are unattractive. The reflection-polarization patterns of black, white, red and yellow cars were measured in the red, green and blue parts of the spectrum. In the blue and green, the degree of linear polarization p of light reflected from red and black cars is high and the direction of polarization of light reflected from red and black car roofs, bonnets and boots is nearly horizontal. Thus, the horizontal surfaces of red and black cars are highly attractive to red-blind polarotactic water insects. Thep of light reflected from the horizontal surfaces of yellow and white cars is low and its direction of polarization is usually not horizontal. Consequently, yellow and white cars are unattractive to polarotactic water insects. The visual deception of aquatic insects by cars can be explained solely by the reflection-polarizational characteristics of the car paintwork.
http://jeb.biologists.org/content/jexbio/200/7/1155.full.pdf; Polarization pattern of freshwater habitats recorded by video polarimetry in red, green and blue spectral ranges and its relevance for water detection by aquatic insects; Gábor Horváth and Dersö Varjú The Journal of Experimental Biology 200, 1155-1163 (1997); wherein the authors disclose that the reflection-polarization patterns of small freshwater habitats under clear skies can be recorded by video polarimetry in the red, green and blue ranges of the spectrum. In this paper, the simple technique of rotating-analyzer video polarimetry is described and its advantages and disadvantages are discussed. It is shown that the polarization patterns of small water bodies are very variable in the different spectral ranges depending on the illumination conditions. Under clear skies and in the visible range of the spectrum, flat water surfaces reflecting light from the sky are most strongly polarized in the blue range. Under an overcast sky radiating diffuse white light, small freshwater habitats are characterized by a high level of horizontal polarization at or near the Brewster angle in all spectral ranges except that in which the contribution of subsurface reflection is large. In a given spectral range and at a given angle of view, the direction of polarization is horizontal if the light mirrored from the surface dominates and vertical if the light returning from the subsurface regions dominates. The greater the degree of dominance, the higher the net degree of polarization, the theoretical maximum value being 100% at the Brewster angle for the horizontal E-vector component and approximately 30% at flat viewing angles for the vertical E-vector component. The authors have made video polarimetric measurements of differently colored fruits and vegetables to demonstrate that polarized light in nature follows this general rule. The consequences of the reflection-polarization patterns of small bodies of water for water detection by polarization-sensitive aquatic insects are also discussed.
http://neuroscience.oxfordre.com/view/10.1093/acrefore/9780190264086.001.0001/acrefore-9780190264086-e-109; Sensing Polarized Light in Insects; Thomas F. Mathejczyk and Mathias F. Wernet; (Subject: Sensory Systems, Invertebrate Neuroscience). Online Publication Date: September 2017; wherein it is disclosed that evolution has produced vast morphological and behavioral diversity amongst insects, including very successful adaptations to a diverse range of ecological niches spanning the invasion of the sky by flying insects, the crawling lifestyle on (or below) the earth, and the (semi-)aquatic life on (or below) the water surface. Developing the ability to extract a maximal amount of useful information from their environment was crucial for ensuring the survival of many insect species. Navigating insects rely heavily on a combination of different visual and non-visual cues to reliably orient under a wide spectrum of environmental conditions while avoiding predators. The pattern of linearly polarized skylight that results from scattering of sunlight in the atmosphere is one important navigational cue that many insects can detect. This article summarizes progress made toward understanding how different insect species sense polarized light. First, presenting behavioral studies with “true” insect navigators (central-place foragers, like honeybees or desert ants), as well as insects that rely on polarized light to improve more “basic” orientation skills (like dung beetles). Second, providing an overview over the anatomical basis of the polarized light detection system that these insects use, as well as the underlying neural circuitry. Third, emphasizing the importance of physiological studies (electrophysiology, as well as genetically encoded activity indicators, in Drosophila) for understanding both the structure and function of polarized light circuitry in the insect brain. Also discussed is the importance of an alternative source of polarized light that can be detected by many insects: linearly polarized light reflected off shiny surfaces like water represents an important environmental factor, yet the anatomy and physiology of underlying circuits remain incompletely understood.

The phytochemical and phytonutrient content and composition are affected by, and respond to the plant light and microclimate environment. The effects of light spectrum on phytochemical content are well documented, and based on studies of photoselective covers, as well as by colored illumination. The various embodiments of the growth chamber units of the present disclosure are combining a growth-chamber, a microclimate protective effect, together with manipulation of the light environment. Therefore, by choosing the right color, and based on prior knowledge, the growth chambers are potentially promoting (or inhibiting) the production of desired phytochemicals because (1) it might depend on the plant species/cultivar of interest, (2) the phytonutrients of interest are different for different crops, and (3) microclimate and cultivation factors play their role as well. Phytochemicals that can be of nutritional and/or health value (bioactive, therapeutic, compounds) include anti-oxidants, vitamins, flavonoids, phenolic acids and other phenolics, carotenoids, terpenoids, alkaloids, etc.

To date, the best color(s) and the means for reflecting those colors utilizing the growth chamber units of the present disclosure to affect the best outcomes for desired phytochemicals is yet to be determined with any certainty, because there are so many colors and surface combinations versus the number of target grape vine varieties and other agricultural crop plants where use of the growth chamber units is planned. Additional review of the literature and planned plant trials by the inventors will help narrow the list of possibilities.

Among the non-limiting publications found in literature are:
https://patents.google.com/patent/US20070151149A1/en (Abandoned); Methods for Altering the Level of Phytochemicals in Plant Cells by Applying Wavelengths of Light from 400 nm to 700 nm and Apparatus Therefore; wherein an Abstract indicates: “A method of altering the level of at least one phytochemical in a plant cell comprising chlorophyll or in plant tissue comprising chlorophyll by irradiating the said plant cell or plant tissue with light of at least one wavelength selected from the range of wavelengths of from 400 nm to 700 nm, use of wavelengths of light selected from said range for altering the level of phytochemicals in plant tissue, harvested plant parts comprising altered levels of phytochemicals, and apparatuses for generating plant tissue having altered levels of phytochemicals therein.”
https://onlinelibrary.wiley.com/doi/abs/10.1002/jsfa.6789; Effects of Light Quality on the Accumulation of Phytochemicals in Vegetables Produced in Controlled Environments: A Review. Zhong Hua Bian, Qi Chang Yang, Wen Ke Liu; wherein it is noted that phytochemicals in vegetables are important for human health, and their biosynthesis, metabolism and accumulation are affected by environmental factors. Light condition (light quality, light intensity and photoperiod) is one of the most important environmental variables in regulating vegetable growth, development and phytochemical accumulation, particularly for vegetables produced in controlled environments. With the development of light-emitting diode (LED) technology, the regulation of light environments has become increasingly feasible for the provision of ideal light quality, intensity and photoperiod for protected facilities. This review discusses the effects of light quality regulation on phytochemical accumulation in vegetables produced in controlled environments are identified, highlighting the research progress and advantages of LED technology as a light environment regulation tool for modifying phytochemical accumulation in vegetables. © 2014 Society of Chemical Industry.
Latifeh Ahmadi, Xiuming Hao and Rong Tsao; The Effect of Greenhouse Covering Materials on Phytochemical Composition and Antioxidant Capacity of Tomato Cultivars, Journal of the Science of Food and Agriculture, 98, 12, (4427-4435), (2018); wherein it was disclosed that the type of covering material and type of diffusion of light simultaneously affected the reducing power of cultivars. Two-way analysis of variance showed statistically significant differences in total phenolic content for the different cultivars (P<0.05) but not for the covering materials. Analysis by ultrahigh-performance liquid chromatography with diode array detection and liquid chromatography/tandem mass spectrometry showed the presence of major phenolic acid compounds. The study concluded that that the use of solar energy transmission could positively affect the reducing power of cultivars and alter the biosynthesis of certain phytochemicals that are health-beneficial.
https://www.mdpi.com/1420-3049/22/9/1420; Md. Mohidul Hasan, Tufail Bashir, Ritesh Ghosh, Sun Keun Lee and Hanhong Bae, An Overview of LEDs' Effects on the Production of Bioactive Compounds and Crop Quality, Molecules, 22, 9, (1420), (2017); wherein it was disclosed that exposure to different LED wavelengths can induce the synthesis of bioactive compounds and antioxidants, which in turn can improve the nutritional quality of horticultural crops. Similarly, LEDs increase the nutrient contents, reduce microbial contamination, and alter the ripening of postharvest fruits and vegetables. LED-treated agronomic products can be beneficial for human health due to their good nutrient value and high antioxidant properties. Besides that, the non-thermal properties of LEDs make them easy to use in closed-canopy or within-canopy lighting systems. Such configurations minimize electricity consumption by maintaining optimal incident photon fluxes. Interestingly, red, blue, and green LEDs can induce systemic acquired resistance in various plant species against fungal pathogens. Hence, when seasonal clouds restrict sunlight, LEDs can provide a controllable, alternative source of selected single or mixed wavelength photon source in greenhouse conditions.
Shahak, Y. (2014) Photoselective netting: An overview of the concept, R&D and practical implementation in agriculture. Acta Horticulturae (ISHS) 1015: 155-162; wherein one of the inventors describes the results of research that has taken place over the past 20+ years with the development of photoselective netting, beyond its mere protective functions. Of particular note, the research revealed multiple benefits to the low-shading photoselective netting of fruit tree crops, traditionally grown un-netted (e.g. apples, pears, persimmon, table-grapes). The photoselective responsive parameters included enhanced productivity, improved water use efficiency, better fruit maturation rate, increased fruit size, and improved fruit quality. Further still, the photoselective netting was found to mitigate extreme climatic fluctuations, reduce heat, chill and wind stresses, enhance photosynthesis, enhance canopy development and reduce fruit sunburn.
Rajapakse, N. C. and Shahak, Y. (2007); Light Quality Manipulation by Horticulture Industry. In: Light and Plant Development (G. Whitelam and K. Halliday, eds.), pp 290-312, Blackwell Publishing, UK: wherein in chapter 12, section3: Plant Responses to Quality of Light, pgs. 292 & 293; one of the coauthors and an inventor herein describes plant responses to the quality of light for effects on phytochemicals (antioxidants) that contribute to the overall quality and protect plant cells from oxidative damage by external factors, such as excessive sunlight, temperature, and pest and disease infections. Further, UV-B radiation has been shown to decrease both ascorbic acid and β-carotene concentrations. In early work, UV radiation was thought to be the most effective in stimulating anthocyanin production. Longer wavelength radiation, red in particular, is also effective in stimulating anthocyanin and other flavonoid biosyntheses. Further still, Carotenoid biosynthesis has been shown to be under phytochrome control. Exposure to red light increased lycopene accumulation over twofold during tomato fruit ripening, an effect that was shown to be far-red light reversible. Environmental regulation of health-beneficial phytochemicals in food crops is poorly understood at present and more research will be needed to best determine how the present invention will best support health-beneficial phytochemical production.
Shahak, Y., Kong, Y. and Ratner, K. (2016); The Wonders of Yellow Netting. Acta Horticulturae (ISHS)1134: 327-334. DOI 10.17660/ActaHortic.2016.1134.43; wherein the Abstract indicates: “Photoselective netting is an innovative technology, by which chromatic elements are incorporated into netting materials in order to gain specific physiological and horticultural benefits, in addition to the initial protective purpose of each type of net (shade-, anti-hail-wind-, insect-proof, etc.). Field studies of plant responses to the photoselective filtration of solar radiation by these nets had provided vast amounts of productive horticultural knowledge, which is already being applied by growers, worldwide. Yet, the particular physiological mechanisms behind the apparent responses could not always be revealed, since these studies were carried under the ever changing environments of light, microclimate and agricultural practices. Physiological understanding can, however, be deduced by analyzing the similarity and variability in the responses of different crop species/cultivars grown in different environments to particular photoselective nettings, and by linking the field results with the molecular knowledge gained under fully controlled conditions. We had previously reported that while Blue shade nets slow down vegetative growth and induce dwarfing in ornamental foliage and cut-flower crops, Red and Yellow nets that reduce the relative content of blue light, are stimulating vegetative vigor. Between the latter two nets, the Yellow repeatedly exceeded the Red net in its stimulating effects. Studies in table grapes revealed that both the Red and Yellow nets delayed fruit maturation, and again the effect of the Yellow exceeded the Red net. The Yellow net additionally surpassed the Red net in its berry enlarging effect. In sweet peppers both Red and Yellow shade nets increased productivity. However, the Yellow, but not the Red net additionally reduced pre- and postharvest fungal decay of the fruit. The latter effect coincided with elevated anti-oxidant accumulation under the Yellow net. This paper discusses crop responses to Yellow netting, and infers a possible connection with the recently proposed green photoreceptor, awaiting its discovery.”
https://www.sciencedirect.com/science/article/pii/S1011134416302743; Spectral Quality of Photo-selective Nets Improves Phytochemicals and Aroma Volatiles in Coriander Leaves (Coriandrum sativum L.) After Postharvest Storage; Millicent N. Duduzile Buthelezi, Puffy Soundy, John Jifon, Dharini Sivakumar; wherein the Abstract indicates: “The influence of spectral light on leaf quality and phytochemical contents and composition of aroma compounds in coriander leaves grown for fresh use under photo-selective nets; pearl net [40% shading; and 3.88 blue/red ratio; 0.21 red/far red ratio; photosynthetic radiation (PAR) 233.24 (μmolm(−2)s(−1))] and red net [40% shading and 0.57 blue/red ratio; 0.85 red/far red ratio; 221.67 (μmolm(−2)s(−1))] were compared with commercially used black nets [25% shading; 3.32 blue/red ratio 0.96 red/far red ratio; 365.26 (μmolm(−2)s(−1))] at harvest and after 14 days of storage. Black nets improved total phenols, flavonoid (quercetin) content, ascorbic acid content, and total antioxidant activity in coriander leaves at harvest. The characteristic leaf aroma compound decanal was higher in leaves from the plants under the red nets at harvest. However, coriander leaves from plants produced under red nets retained higher total phenols, flavonoids (quercetin) and antioxidant scavenging activity 14 days after postharvest storage (0° C., 10 days, 95% RH and retailers' shelf at 15° C. for 4 days, 75% RH). But production under the pearl nets improved marketable yield reduced weight loss and retained overall quality, ascorbic acid content and aroma volatile compounds in fresh coriander leaves after postharvest storage. Pearl nets thus have the potential as a pre-harvest tool to enhance the moderate retention of phytochemicals and saleable weight for fresh coriander leaves during postharvest storage.”

### Replant Trials and Results

As noted previously, a common practice in older vineyards is to replace vines that are no longer healthy or productive with new vines planted at their side. The older vine is retained until the replant has become established, and then the older vine is removed. About 20 to 30 replant vines per acre are typical planted annually. The replant vine becomes heavily shaded by the canopy of the vineyard by early-June and growth slows or stops. As a result, it takes several years before the replant becomes established and productive. Application of a device as described herein potentially will cut establishment time in half. Equipment could be reused so that the growers would have an inventory of equipment to use on an annual basis.

The growth chamber units of the present disclosure were engineered to manipulate the spectra of radiation and to diffuse the light reaching the vine in order to positively impact morphology and physiology. Research in 2017 and 2018 showed the growth chamber units greatly accelerated the development of the young vine trunk and fruiting wood. Compared to control vines, the rate of shoot (trunk) growth was more than doubled, leaves were larger, total leaf chlorophyll was increased, and lateral growth (next year's fruit wood) was much greater (see Soledad, Sonoma, Woodlake reports below).

Root development was not measured, but the health and size of the root system is a reflection of the canopy and trunk system. It is surmised therefore, that the growth chamber units had a positive impact on the root system similar to the positive impact on trunk and canopy development. (Note: The only way the root system could be evaluated accurately is to intentionally destroy the vine and expose the roots by washing away the soil. This is something that growers at the test sites frown upon).

By the end of the growing season, better wood maturity was apparent with vines growing within the growth chamber units, and wood maturity was evaluated during dormancy. Wood maturity is associated with the lignification and storage of carbohydrates as the green shoot develops into a woody cane by seasons end. Wood maturity is required for the cane to survive the winter and carbohydrate storage supports bud break and shoot growth the following spring. The Chambers were removed in February, but the increase in fruit wood size and maturity resulting from the application of the Chamber will benefit vine development into the following year(s), and it is expected that yields in the second year could be doubled or tripled, and yield increases will likely continue with subsequent seasons.

These expected improvements are clearly supported in literature as noted herein:
https://www.cambridge.org/core/journals/new-phytologist/article/responses-of-tree-fine-roots-to-temperature/C23A26C1823F38A5A2EBD9CA1566E9B7: Pregitzer, K., King, J., Burton, A., & Brown, S. (2000). Responses of tree fine roots to temperature. New Phytologist, 147(1), 105-115; wherein it is noted: “Limited data suggest that fine roots depend heavily on the import of new carbon (C) from the canopy during the growing season. It was hypothesized that root growth and root respiration are tightly linked to whole-canopy assimilation through complex source-sink relationships within the plant.”
https://nph.onlinelibrary.wiley.com/doi/full/10.1111/j.1469-8137.2005.01456.x; Canopy and environmental control of root dynamics in a long-term study of Concord grapes; wherein it was disclosed that there was continual root production and senescence, with peak root production rates occurring by midseason. Later in the season, when reproductive demands for carbon were highest and physical conditions limiting, few roots were produced, especially in dry years in non-irrigated vines. Root production under minimal canopy pruning was generally greater and occurred several weeks earlier than root production under heavy priming, corresponding to earlier canopy development. Initial root production occurred in shallow soils, likely due to temperatures at shallow depths being warmer early in the season. In general, the study showed direct and intricate relationships between internal carbon demands and environmental conditions regulating root allocation. More specifically, the authors found partial support for their hypotheses on factors affecting root production in Concord grape. Minimal pruning promoted earlier spring root development, which coincided with the earlier canopy development of minimally pruned vines compared with those heavily pruned. Size of root populations among the pruning and irrigation treatments of vines fluctuated between years and different times in the season, governed by endogenous and, as well as, exogenous factors at various times. Compared with minimal dormant pruning, the authors found that vines under heavy pruning produced fewer fine roots. Irrigation allowed more root production in dry years and affected the vertical distribution of roots in the soil profile. Heavy reproductive growth was generally associated with lower starch reserves in woody roots, implying that stored reserves may have been used for reproductive growth. In the latter part of the season, few roots were produced once reproductive development reach stages of high carbon demand on the vines. Across different years, heavy reproductive growth in a given year was associated with higher fine root production in the early part of the following year, indicating that greater reproductive allocation did not entirely hamper allocation to roots.
   Further it was suggested that environmental cues may be part of a signal for initial root production (Fitter et al., 1999; Tierney et al., 2003), but at least a portion of root production appears to be regulated by endogenous factors, possibly linked to photosynthetic supply. Whereas spring root production in all treatments was initiated around the time of bud break (FIG. 3), root flushing generally occurred more quickly in minimally pruned vines (FIG. 2a), corresponding to their faster canopy development (FIG. 1). Furthermore, within pruning treatments (and therefore independent of canopy development), the authors found additional evidence of endogenous control on root production with treatments that had larger reproductive allocation allocating more resources to root production in the early season of the following year. Biological reasons for increasing allocation below ground could include the facts that: (1) when vines grow vigorously and support heavy reproductive growth, they may also be able to support more root growth; (2) large reproductive allocation may have required more water and nutrients so that in periods following heavy reproductive growth, vines may have been stimulated to increase allocation to roots, which acquire water and nutrients; or (3) after a season of heavy reproductive growth when vines may not have been able to allocate many resources to roots, vines may have increased allocation to roots to make up for limited allocation during the prior period. Although vines with large reproductive growth had lower starch reserves in roots at the end of one season, increased root production in the early portion of the following year may have still been supported by starch reserves, which were low but not depleted, and by current photosynthates. Research tracking carbohydrate allocation with radioactive isotopes has demonstrated that root growth can be supported by current photosynthate (e.g. Thompson & Puttonen, 1992). Although optimization theory suggests that plants selectively allocate resources to acquire a limiting resource, shifts in allocation may only occur at times of the year, such as the early season, when strong competition from reproductive sinks are not present.
   Still further, the internal carbon balance of the vines may have interacted with irrigation effects, leading to a diminished white root population in minimally pruned vines after two dry years. Minimally pruned vines, which had greater reproductive allocation than heavily pruned vines, did not have reduced capacity to produce roots in a single dry year following a wet year, but after two consecutive dry years, capacity for root production was diminished. Total root populations in minimally pruned vines without irrigation were still greater than those of heavily pruned vines in the second dry year, owing to minimally pruned vines having a large number of brown roots (FIG. 2). However, the metabolic activity of brown roots is low compared with white roots (Comas et al., 2000).
   Both endogenous and exogenous factors may have been responsible for limiting root growth during dry years. First, the second dry year (1999) had more intense drought than the first, which likely limited all root production without irrigation in the dry part of the season. Root production in dry conditions could be retarded owing to environmental conditions such as the soil being too dry to allow for root penetration or carbon limitation for root growth under these conditions. While photosynthesis is often reduced under dry soil conditions and could lead to carbon limitations on root growth, root respiration and growth are also greatly reduced, often leading to an increase of starch reserves in plants experiencing drought (Bryla et al., 1997). Root growth of woody plants in climates with seasonal water patterns is often limited at dry times in the season when water is not available (e.g. Katterer et al., 1995). Second, in 1999, reproductive allocation was 70 and 30% higher for heavily pruned and minimally pruned vines than in 1998, which, combined with reduced photosynthesis, may have greatly limited supply of current photosynthates for root growth. The delay in root production in non-irrigated vines during the wet spring of 2000 when environmental conditions should have been optimal for root growth might be indicative of carbon stress in vines in non-irrigated treatments after two dry years. Thus, it appears that a combination of factors may have limited root production in non-irrigated vines in dry years, with soil impedance possibly physically restricting root production in dry soil layers, and reduced photosynthesis eventually leading to limiting carbon availability for root growth.
   In conclusion, this study along with others illustrates that the periodicity of root flushes may be jointly regulated by exogenous and endogenous factors: warming temperatures, moisture availability and carbohydrate supply from the shoot triggering root growth in spring; soil moisture limitations and competing carbon sinks restricting root growth in summer; and, in fall, moisture availability and carbohydrate supply from the shoot following harvest, triggering root growth as long as vines do not go immediately into dormancy. The authors detailed examination of root production in Concord grape indicated that timing and quantity of root production was closely associated with canopy development when environmental conditions were favorable. There was little consistency in timing, however, of either peak root production or peak root standing populations from year to year, possibly owing to interactions between the carbon balance in the vines and climatic conditions. Simple predictions of timing of root production or standing population with shoot development, consequently, may not be possible. This study also illustrates the need for multiple years of root observations under field conditions to thoroughly investigate patterns of root dynamics associated with plant carbon balance or climatic conditions; only by understanding year-to-year variation can we interpret the relative strengths of endogenous and exogenous factors.
   https://www.sciencedirect.com/science/article/pii/S136952661100032X; From lab to field, new approaches to phenotyping root system architecture; wherein it is noted that plant root system architecture (RSA) is plastic and dynamic, allowing plants to respond to their environment in order to optimize acquisition of important soil resources. A number of RSA traits are known to be correlated with improved crop performance. There is increasing recognition that future gains in productivity, especially under low input conditions, can be achieved through optimization of RSA. Improvements in phenotyping will facilitate the genetic analysis of RSA and aid in the identification of the genetic loci underlying useful agronomic traits. Specific highlights noted in the article include; 1) Several root system architecture (RSA) traits are correlated with agronomic performance; and 2) Optimizing RSA may increase crop productivity.
https://www.sciencedirect.com/science/article/pii/S0304423818303030; Effects of Photoselective Netting on Root Growth and Development of Young Grafted Orange Trees Under Semi-arid Climate; KainingZhou, DanielaJerszurki, AviSadka, Lyudmila Shlizerman, Shimon Rachmilevitch, Jhonathan Ephrath; Scientia Horticulturae Volume 238, 19 Aug. 2018, Pages 272-280; wherein as noted in the following Abstract: “Photoselective netting is well-known for filtering the intercepted solar radiation, therefore affecting light quality. While its effects on above-ground of plants have been well investigated, the root system was neglected. Here, we evaluated the effects of photoselective netting on root growth and plant development. Minirhizotron and ingrowth cores were applied in a field experiment, performed in a 4-year-old orange orchard grown under three different photoselective net treatments (red, pearl, yellow) and an un-netted control treatment. Our observations confirmed the significant positive effect of photoselective nets on tree physiological performance, by increases of photosynthesis rate and vegetative growth. Trees grown in the pearl plot developed evenly distributed root system along the observation tubes while trees in control, red and yellow plots had a major part of roots concentrated at different depth ranges of 60-80, 100-120, and 120-140 cm, respectively. Photoselective nets showed a strong impact on shoot-root interaction and proved equally successful in promoting rapid establishment of young citrus trees. However, at long-term effect, yellow net might outperform because it could enable plants to develop deeper root systems, which will uptake water and nutrients more efficiently in semi-arid areas with sandy soil.”

This noted photoselective effect on the roots correlates well with the effect on canopy development: wherein the pearl net was reported (in more than one of one of the inventors articles (Shahak, Y.) to promote lateral, bushy growth, while the red, and even more so the yellow nets enhance elongation.

A first (original) trial was located in an established raisin vineyard in Woodlake, Calif. The Replant experiment was initiated in August, 2017, to evaluate the impact of the illumination device on replacement vines that were planted in April, 2017. The experiment was designed as a completely randomized block design with seven blocks and three treatments. Treatments were as follows: 1. Control (no device); 2. The device with a small diameter; and 3. The device with a large diameter. Both trunk diameter and shoot growth were measured as a means of monitoring growth.

At the outset, trunk diameters were measured, marking the site on the trunk for future measurements. To monitor shoot growth, a node a few inches below the shoot tip was tagged and the distance from the tag to the shoot tip was measured, and subsequent measurements were taken from marked node to the shoot tip. The tag units were made of shiny, highly reflective metal, and composed of a canopy-type collector of either full size (Large) or half size (Small), connected to a semi-open down-tube. Replication 1 thru 4 involved placing the device adjacent the newly planted vine. Replication 5 to 7 involved placing the vine inside the barrel of the device.

### Original Replant Trial, 1^{st} Year Results (2017)

The replant trial was a success. The growth chamber devices accelerated the growth of replanted vines in an established vineyard (Table 1). This was quite remarkable considering that the installation occurred late in the summer when normal growth declines. Also, it should be noted that it takes time for a grapevine to adjust and begin growing again, having been shaded for several months and then suddenly exposed to light. It was apparent that in order to maximize growth, the growth chamber devices should have been in place soon after the vines were planted. Providing light during June and July is critical in order to maximize growth.

The growth chamber devices, when placed to the side of the replant, improved vine growth (shoot and trunk), and results were similar for the small and large tubes. Placing the tube on top of the vine resulted in some leaf and tip burn from apparently receiving too much radiation (heat and light), and thus vines growing inside the large tube had more damage than those growing beside small tubes.

TABLE 1
Replant vine growth response to Growth Chamber - 2017

| | Trunk Growth | Shoot Growth |
|---|---|---|
| | Aug. 3 to Sept. 1 | Aug. 3 to Sept. 1 |
| Treatment | (mm diameter) | (mm growth) |
| 1. Control: No | 0.2 | 1.2 |
| Growth | | |
| Chamber | | |
| 2. Growth | 1.12 | 35.6 |
| Chamber Small | | |
| Collector | | |
| 3. Growth | 3.08 | 25.0 |
| Chamber Large | | |
| Collector | | |

### Original Trial 2^{nd} Year Results

The same units and same design remained for a second season, in the same “original” plot. The differences from 2017: (i) this was a second, successive season; (ii) the units were installed early in the growing season; (iii) all units were placed adjacent to the replanted vines.

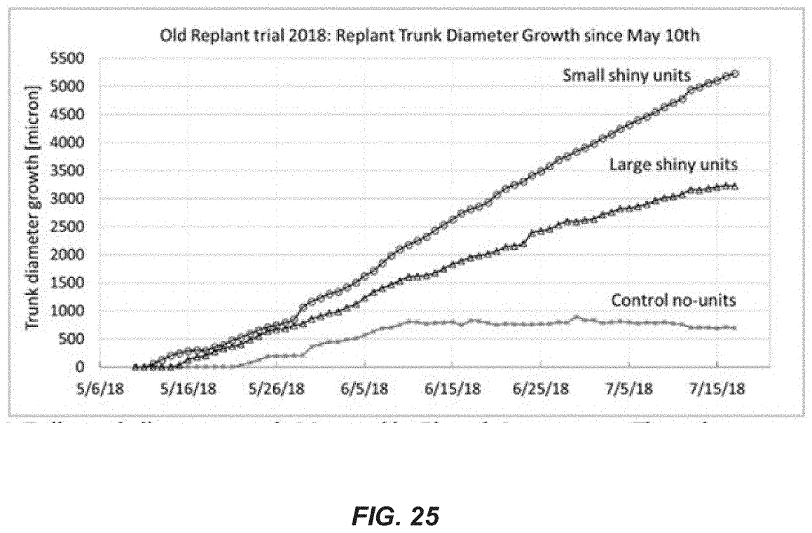

Trunk diameter was monitored by Phytech stem dendrometer sensors, which were installed in early May, 2018. At that time, the canopies of the old vines were already heavily shading and thus limiting the growth of the control replants, while the replants illuminated by the growth chamber device units continued growing steadily throughout the season FIG. 25. Note: The larger shiny units apparently provided excessive radiation (and sunburns), and thus induced lesser growth stimulation, relative to the small units.

### Original Trial Conclusions

The proof of concept was well established in this trial.
The excessive radiation delivered by the first prototype units is actually better news than too little radiation.

Observations and Proposed Improvements
Excessive radiation issues can be solved by
   (i) Better scattering the transmitted radiation;
   (ii) Allowing some microclimate control;
   (iii) Optimizing the spectral composition.
Although the heating effect is not desired in hot climates, it might have beneficial effects in colder climates

### New 2018 Replant Trial—Woodlake, Calif.

Following the above conclusions, a new type of Replant unit was tested, composed of a small, collar-like collector and a downtube containing 4 large holes for training and ventilation. The units were dye-coated and thus less reflective than the former shiny ones. The new trial was established in the same raisin vineyard in mid-April, 2018. The new units were installed over replant vines that had been planted just a week prior.

### New 2018 Replant Experimental Design:

This experimental design utilized completely randomized blocks with 4 treatments (Red, Orange, White coated metal units and a no-unit common practice control) in 15 blocks/repetitions, and using new single vine plots. Shoot length and diameter were measured manually several times along the season. As well as air temperature, humidity and light in the replant vicinity.

### New 2018 Replant Trial Results:

Towards the summer, as the ambient temperatures increased, increasing sunburn damage was observed developing in the new type of Replant unit-treated replant vines, but not in the control replant vines. It was diagnosed to be the result of a combined effect of hot-spots formation inside the new units, together with insufficient ventilation. Therefore, in early-July, 2018, the down-tubes along their south side were opened to provide additional ventilation. Following this opening, most of the vines gradually recovered. Leaving only the second half of the 2018 growing season for meaningful data collection.

In spite of the sunburn issue and its detrimental physiological cost, which masked some of the data, final results show clear positive effects on replant vine growth (elongation and shoot diameter). Especially with the Red unit, which was the best performing design.

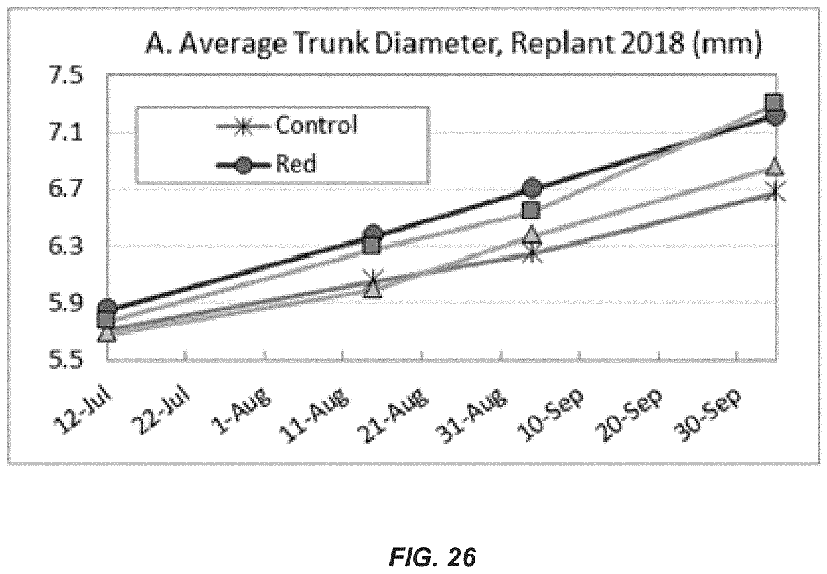

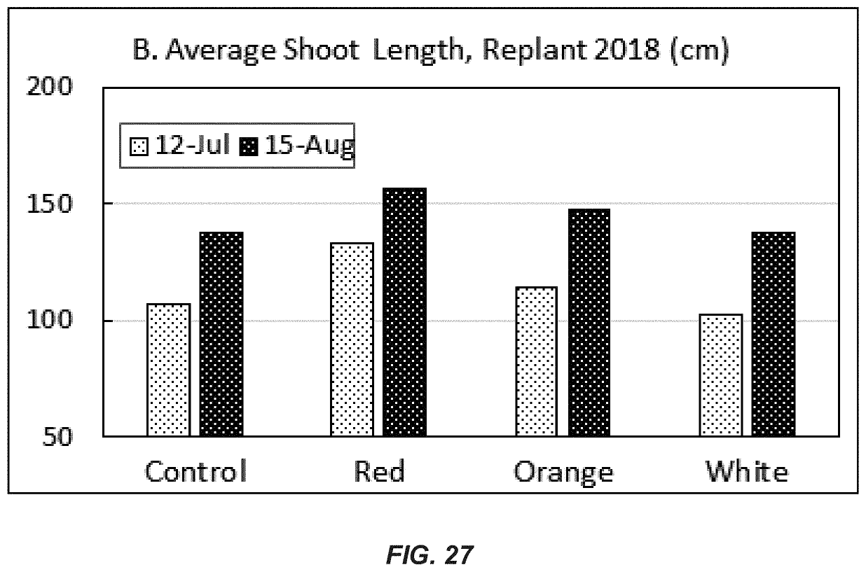

It was expected that further overcoming of the hot spots formation (i.e. by rough inner surface, etc.), along with opening the tube much earlier in the season, would multiply the stimulating effects of the units. FIGS. 26 and 27 show the results of replant trials.

### Economic Implications:

In an older vineyard, 18 to 20 vines per acre are replanted annually. Once fully established, these replant vines will eventually produce 40 to 60 pounds of fruit. Reducing establishment time by even one year would potentially advance a $360 return by one year. This is calculated as follows: 60 pounds/vine×20 vines/acre=0.6 tons (1,200 pounds); crop value of $600 dollars×0.6 tons=$360 per acre advance return. This is almost all gain since the cost of production per acre is fixed, whether or not the replants are in production. This is not a one year only gain as replanting in older vineyards is an annual event.

A conservative estimate is that 100,000 acres of vineyard in California are older than 15 years of age. The potential market is large when you consider that each year at least 10 replant vines per acre are required to sustain the productivity of these older vineyards.

There are other advantages to using the growth chamber devices. The growth chamber system encloses the vine within a tube extending three to four feet above the ground surface. The tube protects the vines from rabbits, deer, and other vertebrate pests. It allows herbicides to be sprayed down the vine row without contacting young, susceptible tissue. It provides wind protection and frost protection. Finally, the growth chamber will act as a means of training vines reducing the amount of hand labor required to train the shoot that will become the trunk.

### First Newplant 2018 Trial—Monterey, Calif.

The Monterey trial site was located in a Pinot Noir vineyard near Soledad, Calif., planted in May 2017, as green vines in short paper sleeves. The local climate is typically cool and windy, and thus newly planted vine growth is very slow. The trial was installed in early May, 2018, when the second-year vine growth was just beginning. The experimental layout consisted of a completely randomized block design, with twenty blocks/repetitions, four treatments, and using single vine plots. Treatments consisted of Red, Orange, and White growth chamber units along with an untreated (no-unit) control. On a weekly basis, shoot growth was measured during the vine training phase up the stake. Vines reaching the top of the training stake were tipped, and then the lateral, secondary shoot growth (future cordons) was measured. The dates vines were tipped was documented, and then the percentage of vines tipped as the season progressed was plotted.

### Monterey Newplant Trial Major Results

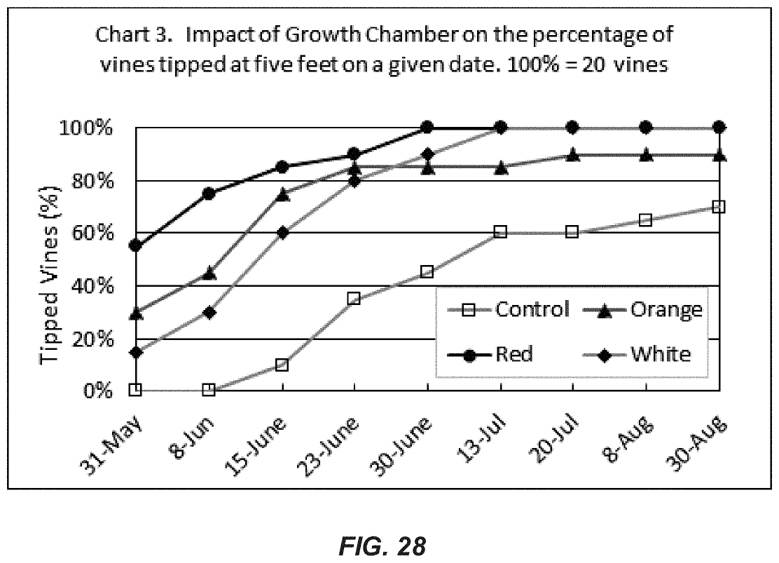

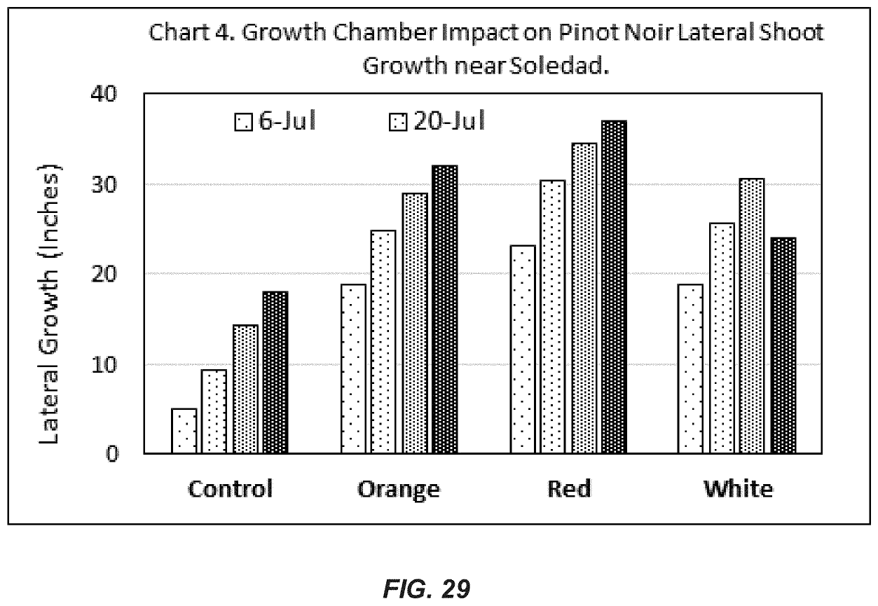

This trial produced spectacular results. The Red unit was the most effective. It increased the average rate of shoot growth from 13 mm/day in the control up to 33 mm/day. Vines were trained up the stakes and tipped at five feet to begin establishing cordons (single wire). One hundred percent of the Red unit vines were tipped by as early as June 30, whereas only 45% of the control vines were tipped by that same date, as noted in FIG. 28. Thirty percent of control vines still had not been tipped by August 30. Lateral growth was documented following tipping of the vines. By September 5, average lateral growth for the Red unit had exceeded three feet, whereas the lateral shoot growth of control vines was about half that amount, as noted in FIG. 29.

Additional Point of Interest:
(i) It was observed that the green leaves inside the growth chamber units had developed to distinctly larger size relative to the control vines. This implies higher photosynthetic activity per vine relative to control vines.
(ii) Additionally observed: Enhanced shoot lignification in the growth chamber unit-treated vines relative to the control vines. Lignified shoots will survive the winter, while green tissues will die and need to be cut-down and re-grow next season. So it was concluded that the growth chamber units were stimulating both the seasonal growth of green shoots, as well as their maturation into perennial woody shoots. Further lignification data will be collected in December, after leaf drop, and is therefore not yet available in numbers.
(iii) Fruit yield data will continue to be collected in both Sonoma and Soledad for the next three years. At Soledad, it is estimated based on the data thus far collected that the increase in yield will be 3 to 5 tons per acre, cumulative over the next several years.

### Second Newplant 2018 Trial—Sonoma, Calif.

The Sonoma trial was located near Sebastopol, Sonoma County, Calif., in a Chardonnay vineyard planted Jun. 6, 2018. It was initiated rather late (Jul. 24, 2018) and thus affected only the second half of the growth season. The trial was designed as a completely randomized block with seven treatments and ten blocks/repetitions. Plots consisted of one vine. Treatments included Red, White, and Orange units, along with a no-unit control. Each of the 3 types of units was tested either closed, or slightly opened towards South. The open unit variation was included to improve ventilation and avoid potential sunburns, based on our Woodlake Replant (warm climate) experience. In retrospective, this was not necessary in this cooler climate. The control vines were spaced by a “buffer vine” away from the unit-treated vines in each block/rep to avoid potential shading and/or microclimate effects by the near-by units. Shoot growth was measured on August 7, August 21, September 6, with the final measurement October 11. Trunk diameter was also measured on those dates.

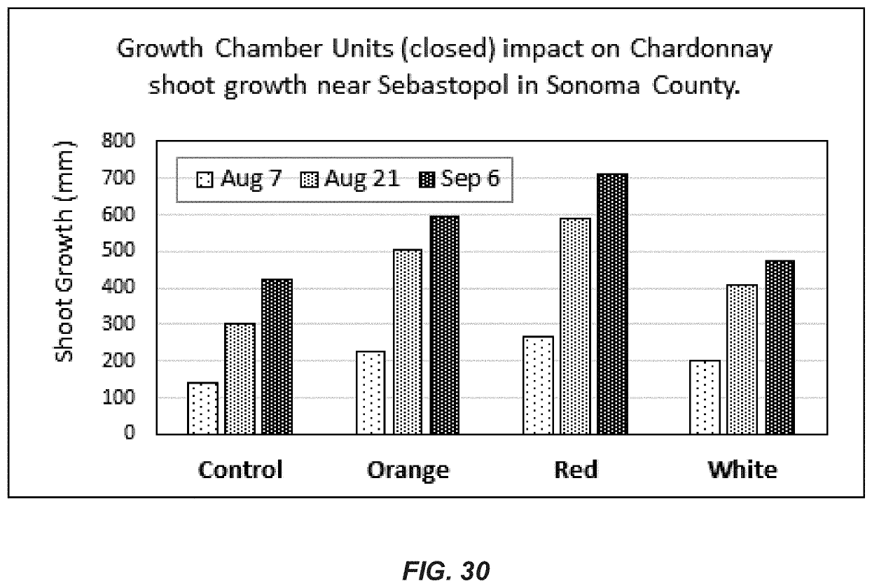

Sonoma 2018 Major Results: In spite of the short time, the units induced pronounced growth stimulation, relative to the no-unit (common practice) control. The best treatment was the Red closed unit. With the closed Red unit, shoot growth was increased by 92% when measured on August 7 (2 weeks into the experiment), and the increase was 67% when measured on September 9 (six weeks into the experiment, FIG. 30). The effects were statistically significant. Opening the units, regardless of color, reduced effectiveness by about 10% (data is not shown in FIG. 30).

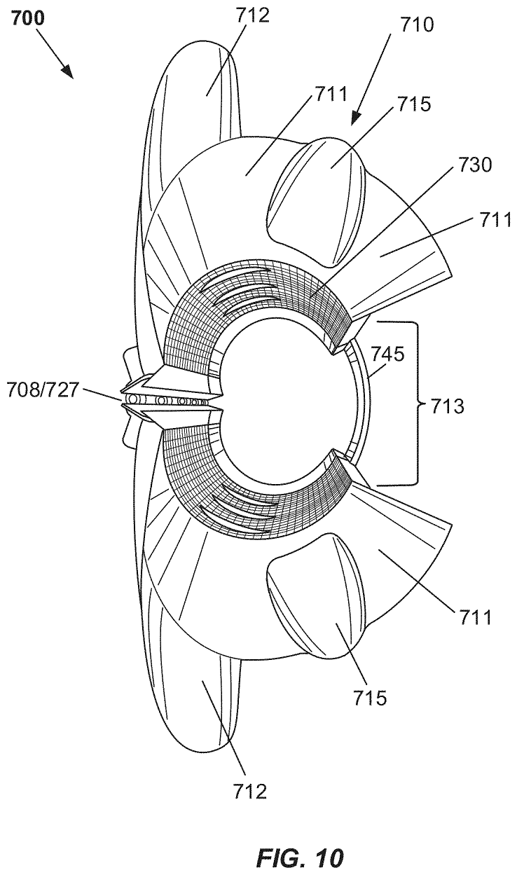

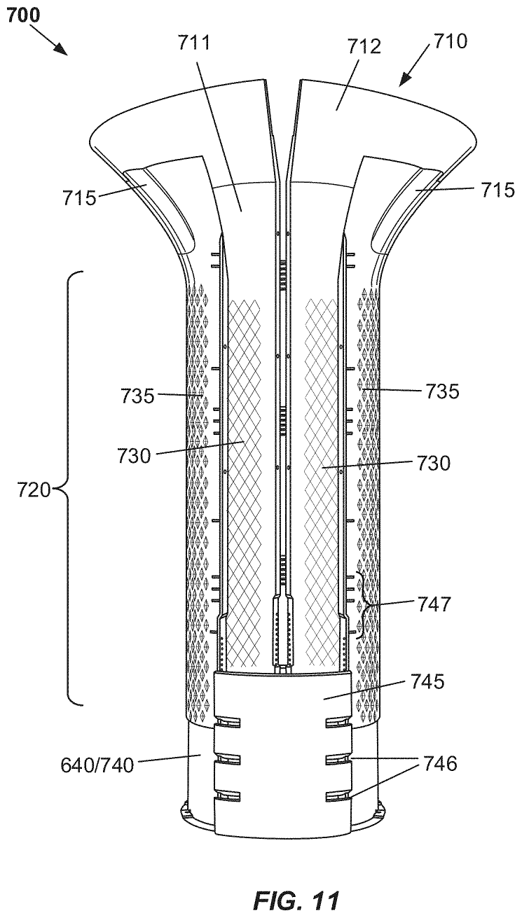

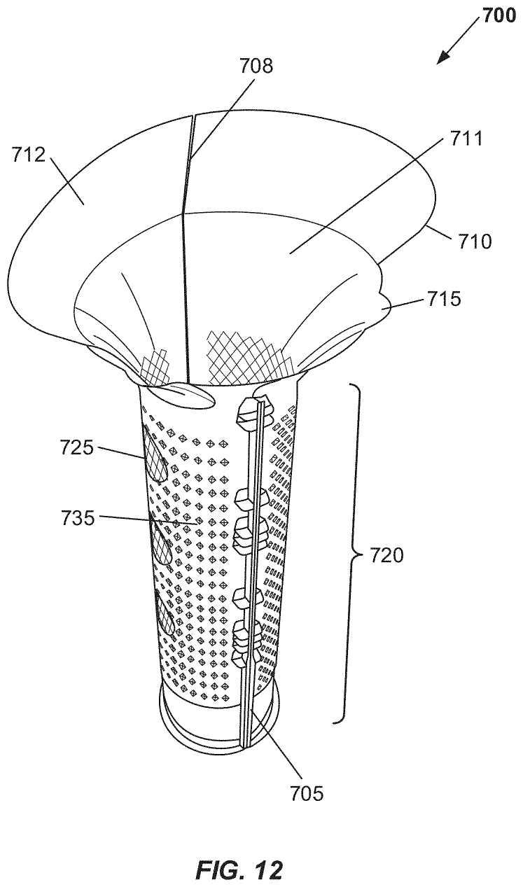

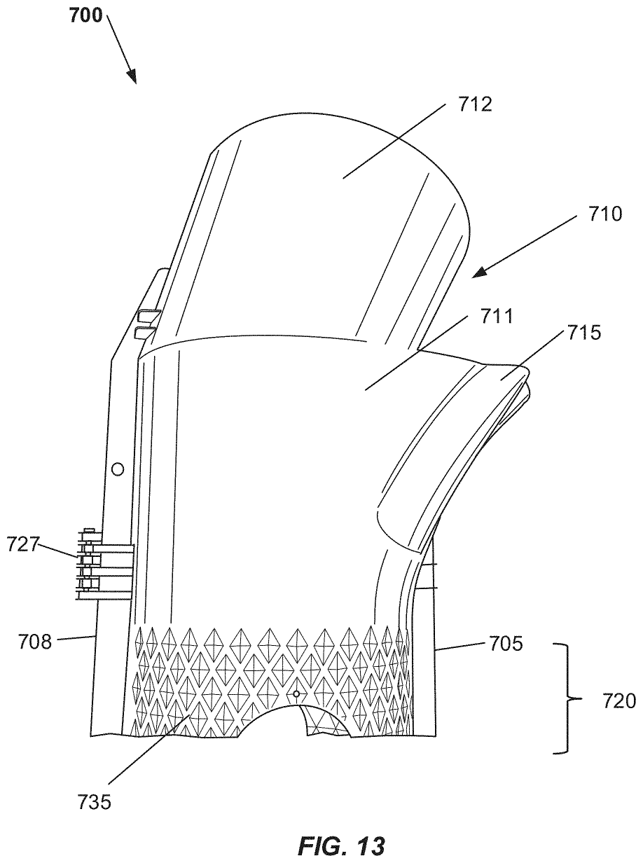

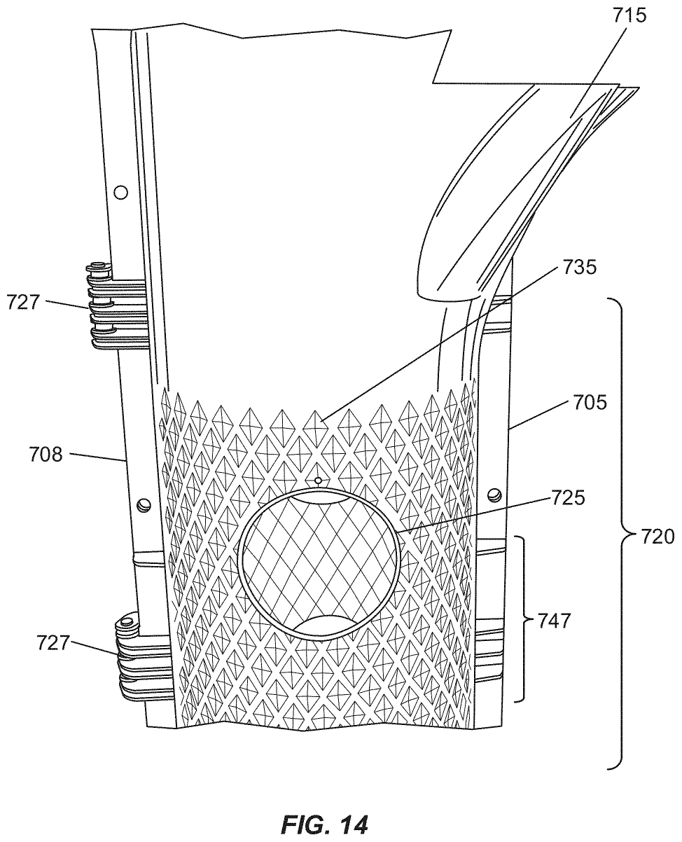

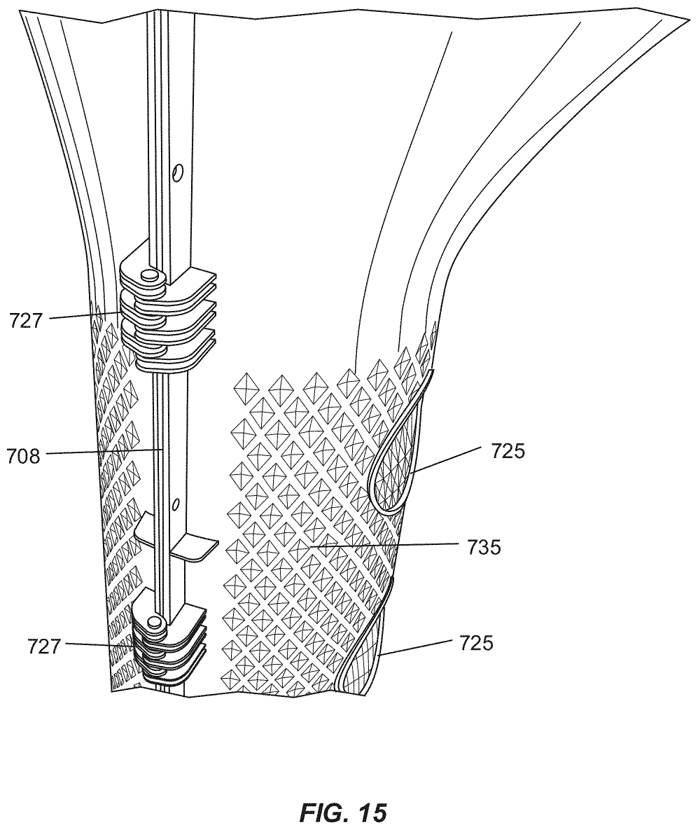

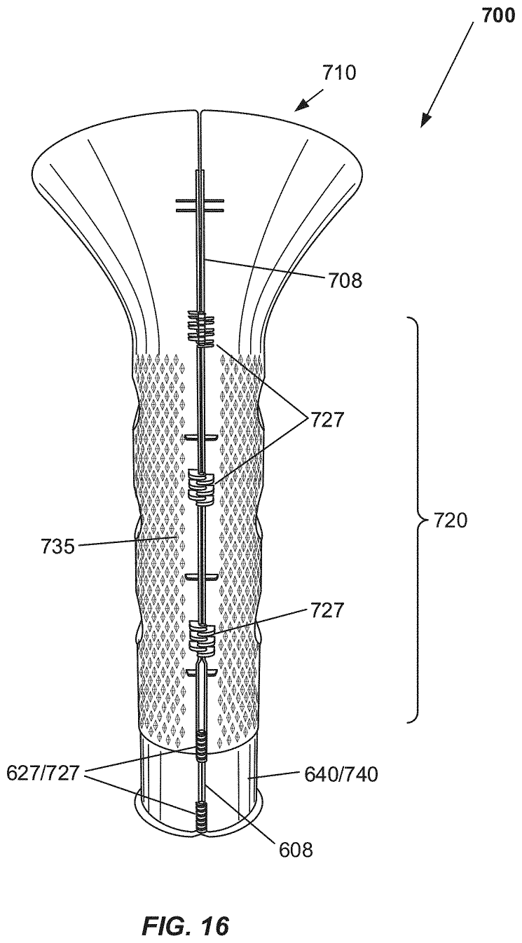

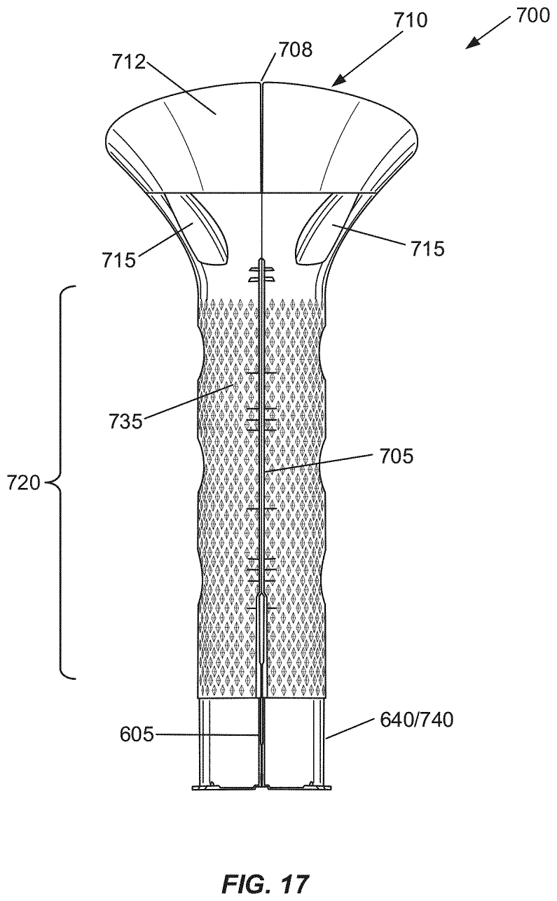

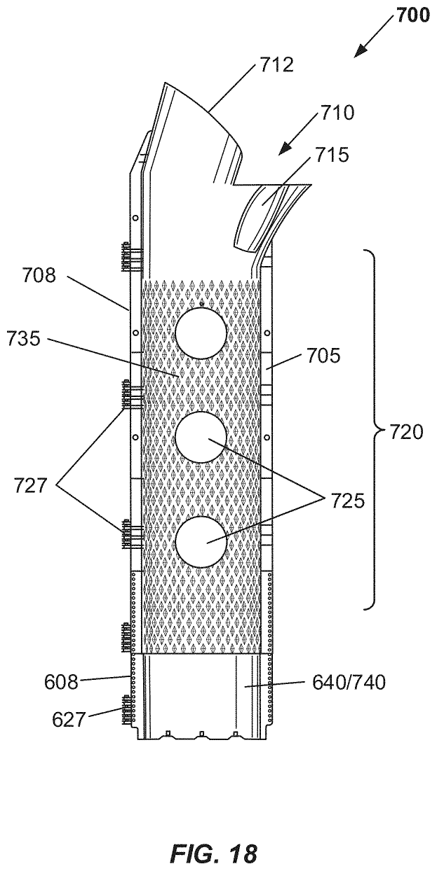

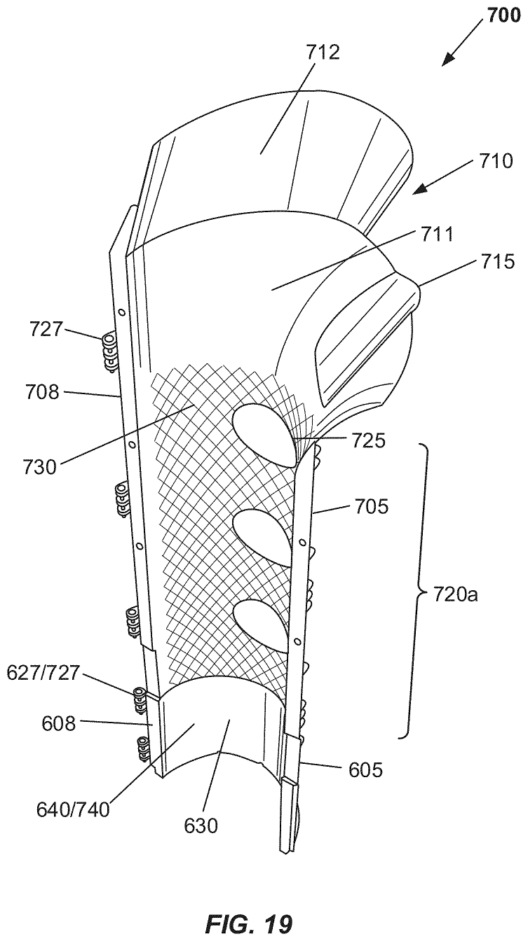

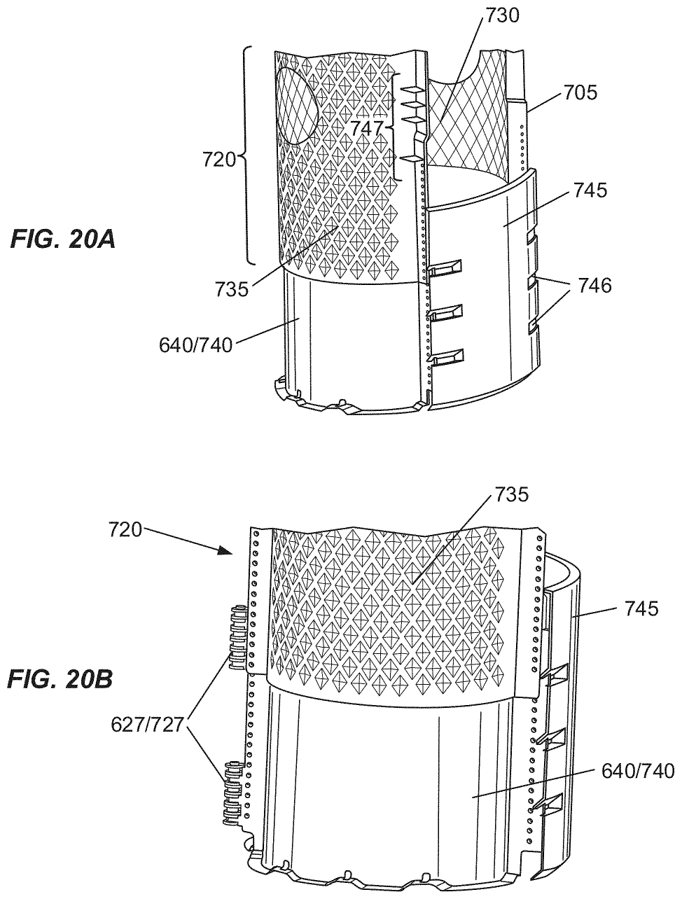

In the new, large-scale trial planned for next year, only Red units will be used. Growth Chamber design engineers have re-designed the units, based on the data collected in the 2018 season, to improve light and temperature management. Construction will be of light weight plastic, easy to install and remove, and provide accessibility for training the vines, as illustrated in FIGS. 7-21. Protection against deer, rabbits and frost protection are further benefits along with shielding young vines from spray damage.

### Additional Trials

Based on the extremely positive results seen to date, additional trials have been scheduled for older climates to confirm the benefits of the growth chamber units and potentially expand the commercial environment for the grapevine industry.

In temperate North America, commercial grapevines of Vitis vinifera are subject to winter injury when temperatures drop below the threshold for vine tissue to survive. Examples of temperate viticulture include the Pacific North West, the Finger Lake region in New York State, Pennsylvania, Ohio, Virginia, South Carolina, South Dakota, Missouri, Tennessee, Texas, Utah, and Saskatchewan—to name but a few.

Vitis vinifera cultivars vary as to their susceptibility to cold temperatures during dormancy. Research has shown that 90% of the buds on a dormant vine can be injured or killed when temperatures reach 5° F. to 15° F. Injury to the vine trunk allows infection of Agrobacterium vitis, and the development of crown gall which further compromises the health of the vine and additional long term production loss.

Washington State University viticulturists have studied in detail the impact of cold temperature during dormancy on the health of both buds and vine vascular tissue, (wine.wsu.edu/extension/weather/cold-hardiness/), incorporated herein by reference). Temperatures that result in bud damage has been accurately defined. Bud damage from freeze is listed at 10%, 50%, and 90% damage. Temperatures that result in phloem and xylem damage within the trunk have also been defined. Values for several cultivars are given in Table 2 below. Root are protected by soil from winter kill except for those roots very close to the soil surface.

In temperate regions subject to winter kill, young vines, especially after their first season of growth, are sometimes buried using plows in the fall to prevent potentially lethal damage from unusually low temperatures. Some growers bury a few low growing shoots during winter dormancy to protect them of freeze damage. These buried canes serve as insurance, allowing vine production to be quickly reestablished in case the unburied portion of the vine is killed by winter freeze. Burying shoots is very expensive and the average cost in New York was almost $600 per acre in 2007, and is likely double that amount today.

Research at the University of Missouri (viticulture.unl.edu/newsarchive/2012wg1001.pdf—incorporated herein by reference) showed that burying canes reduced bud damage on average from 50% down to 10% and the cost at that time was approximately $700 per acre. This level of bud damage reduction would be the goal for the growth chamber units described herein, but at lower cost and with additional benefits: improvement in growth during vineyard establishment, protection against spring frost, protection against weeds sprays and vertebrate pests.

TABLE 2
Bud damage from freeze - (wine.wsu.edu/extension/
weather/cold-hardiness/)

| | Bud10 | Bud50 | Bud60 | PHL10 | XYL10 |
|---|---|---|---|---|---|
| Variety | ° F. | ° F. | ° F. | ° F. | ° F. |
| Chardonnay | 17.0 | 16.5 | 14.5 | 18.0 | 5.5 |
| Cabernet Sauvignon | 17.5 | 16.5 | 15.0 | 15.5 | 4.0 |
| Merlot | 16.0 | 14.5 | 13.0 | 14.0 | 6.0 |
| Syrah | 17.5 | 15.5 | 13.5 | 15.5 | 6.0 |
| Alvarinho | 15.5 | 14.0 | 12.5 | 15.0 | 3.0 |
| Chenin blanc | 18.0 | 17.0 | 14.5 | 15.5 | 4.5 |
| Green Veltliner | 14.0 | 13.5 | 12.5 | 14.0 | 5.5 |

Anticipated Benefits from the Incorporation of the Internet of Things (IoT)

Each replant unit acts to deliver light to an individual vine. The light delivery system can be integrated into an Internet-of-Things controlled via Artificial Intelligence (AI). In addition to manual processes, the system can create a moveable light field whose purpose is to increase or optimize the efficiency of cultivar (agricultural) growth by optimizing the appropriate spectrum for specific growing conditions.

By way of using an expert system and incorporating an AI, a machine learning algorithm, or alternatively, direct control of the reflector, the system would monitor, control and ultimately optimize detailed light characteristics and other variables to increase and optimize yield of specific cultivars.

At a minimum, the IOT/AI system comprises: a light reflector subsystem, at least one (IoT) sensor, a radio, an optical, or comparable communication subsystem, a crop yield measurement subsystem, a processor, a memory and a machine learning algorithm.

It is further anticipated that the IOT/AI system comprises an automatic manipulation subsystem for manipulating both the position and shape of the units, such as the orientation of the light collector, as well as the physical shape thereof utilizing, e.g. via actuators, shape change polymers etc.

Further parameters for anticipated to fall within the IOT/AI system automatic manipulation subsystem comprise:
1. Changing the angle of the collector cone with respect to the downtube—this would be done to increase or reduce the amount of light directed down into the tube as required by a given circumstance;
2. Changing the shape (e.g. bend radius) of the collector cone—again, this would be done to trim light levels or even to selectively position light to certain locations within the tube where sensors have determined more light is required;
3. (2) & (3) Would be used in concert to actively track the position of the sun (daily, and across the seasons) to further optimize light collection;
4. Opening/closing of the downtube: This would be done to vary light levels (especially for early season replants when there is little shading from other vines), and/or to aid in ventilation;
5. Changing the color of units is also anticipated, wherein one would switch from wavelengths that encourage leaf and stem growth over the winter to those helpful for ripening over the summer, through the manipulation of polymer coatings on the collector cone and/or downtube.
6. The internal texture would morph into different shapes, again through the manipulation of polymer coatings, to help control light levels, improve scattering of light within the tube to more evenly distribute light, improve reflectivity and spatial positioning within the downtube.

To optimize the physical shape and hence growth conditions within a unit the machine learning algorithm would make use of any one, or a combination of inputs comprising:

1. Current/historical temperature;

2. Current/historical light levels;

3. Current/historical soil moisture;

4. Current/historical humidity levels;

5. Stem moisture potential;

6. Density of foliage;

7. Color of foliage; or

8. Trunk diameter;

Further still, it is anticipated that the growth chambers of the present disclosure (and or numerous variants contemplated herein, as would be easily understood by one of skill in the art, upon reading this disclosure), will be utilized for other plant species/crops and agricultural sub-industries that would benefit from this technology. Among those other plant species/crops and agricultural sub-industries anticipated comprise:

Outdoor tree nurseries (fruit and/or ornamental plant production);

Orchard replants (e.g. citrus, avocado, stone-fruits);

Newly planted fruit trees; and

Herbaceous crops, (e.g.; especially Cannabis); to name but a few.

As noted previously, although the basics of this technology, namely the combining of enhanced light exposure, spectral modification, and microclimate improvement, applies to the above-mentioned cases and more, the design of the units will require adjustments and adaptations to fit the shape and practices in each of these other plant species/crops and agricultural sub-industries, as would be easily understood by one of skill in the art.

In some embodiments, growth chambers of the present disclosure will incorporate growth-stimulating photoselective and scattering elements, along with plant-vicinity-microclimate manipulation, physical protection and plant-training aids. All of these possible elements will contribute to the final result of shortening the time-to-production in grape vines, and/or trees, and/or other plants.

Noting the previous observations from literature and the inventors herein, and referring now to FIGS. 7-21B, further improvements to the growth chambers have been developed and tested.

As shown in FIGS. 7-11, a growth chamber 700 is illustrated comprising: a solar concentrator 710 for collecting and concentrating solar energy. The solar concentrator comprises a solar-facing surface 711 for collecting a focusing solar light into the growth chamber. The solar concentrator is positioned primarily above a crop plant. The solar-facing surfaces 711, 712, comprising a reflective material or coating. A second component of the growth chamber 700 comprises a light transmitter 720 in optical communication with the solar concentrator 710, for directing the collected solar energy toward the crop plant therethrough, which it surrounds. The light transmitter 720 comprises an inner wall 730 forming a protective zone around the crop plant, the zone comprising a perimeter positioned between the solar concentrator and the crop plant. The inner wall 730 further comprises a reflective inner surface for directing collected solar energy toward the crop plant.

In some embodiments, the reflective material or coating is an adjustable photoselective reflective material.

In some embodiments, the solar-facing surface comprises an offset superior collar 712 extending around a portion of the solar concentrator. Since the main portion of the growth chamber must naturally be positioned vertically for a growing vine, the symmetrical nature of this collar compensates for the fact that the incoming sunlight approaches the units from a somewhat oblique angle. The shape and angle of the collar act to increase the amount of light that would otherwise be collected via a vertically oriented symmetrical cone. Hence the collar is positioned on the north side of the growth chamber in the northern hemisphere and the south side in the southern hemisphere. The angle of the incoming light is dependent upon the latitude of the installation site and some embodiments include a collar that is adjustable in angle relative to the growth chamber to compensate both on a per site basis and also to allow multiple adjustments during the growing season as necessary. The collar extends around the rear half of the growth chamber to maximize the hours of daylight that light is collected. As designed, the offset collar doesn't impede light as it travels across the sky during the day. If it extended further around the growth chamber it would be more efficient during the middle of the day but cause unwanted shading in the early and later hours.

In some embodiments, the collected solar energy comprises selected wavelengths beneficial to the, warmth, growth and/or protection of the plant from predators.

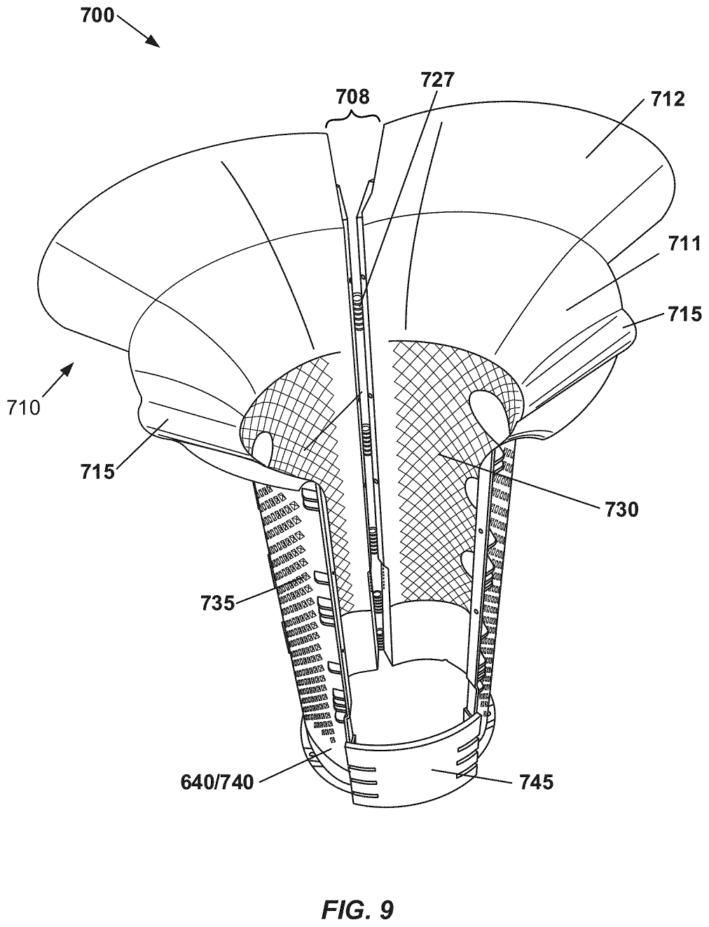

In some embodiments, the solar concentrator further comprises specialized spouts 715 which are provided to assist and train the young shouts and branches of crop plants to directionally orient themselves, as shown in FIGS. 9, 10, 13, 18 and 19. The spouts are concave channels to allow the vine offshoots to align naturally along the wire cordons of the trellis system. They provide a smooth transition between the growth chamber unit and the trellis cordons. They feature soft curved surfaces to minimize potential damage to the shoots due to chaffing during movement caused e.g. by wind.

In some embodiments, the growth chamber further comprises: a textured surface 730 on the inner wall surface of the light transmitter to provide a level of control of light levels and/or spatial light positioning around the crop plant within a downtube of the light transmitter. As illustrated in various embodiments of FIGS. 7, 8, 9 and 11, the texture may comprise a diamond pattern, a waffle pattern or similar geometric-type pattern.

In some embodiments, the adjustable photoselective reflective inner surface color is a shade of red specifically intended to affect light with light of at least one wavelength selected from the range of wavelengths of from 400 nm to 700 nm, providing the noted benefits cited in the literature and field tested by the inventors.

In some embodiments, the growth chamber further comprises a polarized reflective outer surface coating.

In some embodiments, the growth chamber further comprises a textured surface on the outer wall surface 735 of the light transmitter. In some embodiments the exterior pattern will be identical to and the mirror impression of the interior pattern on the inner wall surface 730. This also provides an economic benefit in manufacturing by reducing material costs.

In some embodiments the exterior pattern on the outer wall surface 735 will be different from the interior pattern on the inner wall surface 630, 730.

In some embodiments, the exterior surfaces 735 will comprise a completely different adjustable photoselective reflective surface color.

In some embodiments, the growth chamber 700 further comprises a separable light transmitter base 640, 740, being an optional component of the growth chamber. The separable light transmitter base provides the user with an optional height extender for the light transmitter that can be easily configured to adjust the growth chamber for subsequent seasons of growth for a crop plant. Additionally, the transmitter base 640 doubles as a housing for a heat sink 600 in colder climates.

In some embodiments, the light transmitter base is slidably engaged within the interior of the light transmitter, as illustrated in FIGS. 7-9 and 16-20B. Alternately the light transmitter base is configurable to be slidably engaged over the exterior of the light transmitter.

In some embodiments, the solar concentrator and the light transmitter of the growth chamber are separable, either independently or together, into two or more pieces.

In some embodiments, the entire growth chamber 700 is a singular unit. In some embodiments, the entire growth chamber is configured from segmented components. In some embodiments, the components are segmented along longitudinal planes into two or more components, across all features of the growth chamber, each comprising a portion of the solar concentrator 710, the light transmitter 720 and optionally the light transmitter base 640/740.

In some embodiments, the components are segmented along horizontal planes into two or more components, each as a separate sectional component of the growth chamber, such as the solar concentrator component 710, the light transmitter component 720 and optionally the light transmitter base component 640/740.

In any embodiment of the growth chamber, the entire chamber is configurable from components that are segmentally dividable along both horizontal and longitudinal planes, perimeters or seams, 505, 508, 525, 605, 622 into components which are assemblable along seams or perimeters with attachment features 126, 128, 506, 507, 560, 562, 606, 607, 608 latches 746, 747, hooks, pins 318a,b edge clamps 107, hinges 527, 627 727 or other comparable attachment features, as illustrated in FIGS. 3H, 4A, 4B, 9, 10, 13-19 and 20B.

In some embodiments, the solar concentrator and the light transmitter of the growth chamber are separable along one or more horizontal planes.

In some embodiments, the solar concentrator and the light transmitter of the growth chamber are jointly separable along a vertical plane.

In some embodiments, the solar concentrator and the light transmitter of the growth chamber are jointly separable along a vertical plane and further comprise assembly components along vertical edges 705, 708, or formed at the intersection of the solar concentrator and the light transmitter and the vertical plane.

In some embodiments, the growth chamber further comprises one or more openings 725 in the light transmitter 720.

In some embodiments, the one or more openings 725 provide one or both of: a) operator access to the crop plant therethrough, and b) airflow between the outside environment and an interior of the light transmitter.

In some embodiments, the interior perimeter of the jointly separable components of the growth chamber is expandable such that a first pair of mating vertical edges 708 of the separable components are connectable by hinging mechanisms 727 allowing the growth chamber to book open along a second pair of vertical edges 705 of the separable components, creating a vertical edge opening 713, as illustrated in FIGS. 7, 9, 10 and 11.

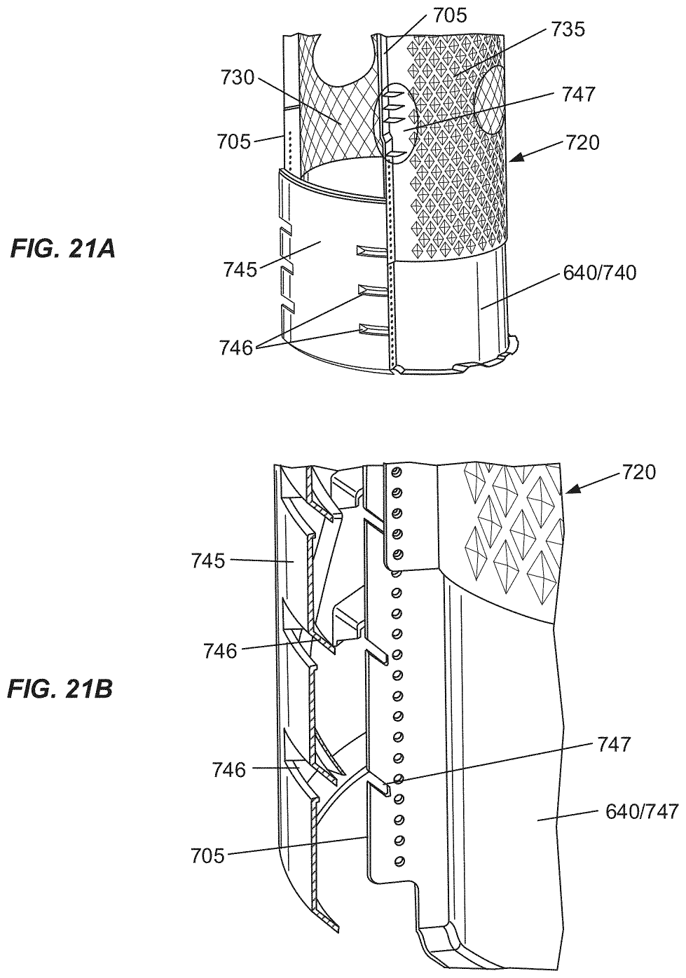

In some embodiments, the second pair of vertical edges 705 of the separable components are releasably connectable by at least one extension panel 745 comprising one or more attachment receivers 746 for connecting to one or more attachment features 747 along the second pair of vertical edges 705 of the separable components, as shown in FIGS. 7, 8, 11, 20A, 21A and more specifically in FIG. 21B. The at least one extension panel 745, also serves to protect the young replants and crop plants from excess exposure to low sprayed pesticides, frost, and excess water runoff which might otherwise be fatal to the crop plant. Further, the at least one extension panel 745, also serves to secure the booked-open sections of the growth chamber and strength and stability to the sectionable structure.

In some embodiments, the textured outer wall 730 comprises pest-control aide color selected from the group consisting of: yellow; pearl-white; highly reflective metallic silver or gold; and adjacent shades in the spectrum thereof.

In some embodiments, the textured outer wall comprises: an external reflective polarization material coating comprising; a nano-particle coating; a photochromic treatment; a polarized treatment; a tinting treatment; a scratch resistant treatment; a mirror coating treatment; a hydro-phobic coating treatment; an oleo-phobic coating treatment; or a combination thereof, wherein the reflective polarization coating reflects light comprising a selected spectrum of wavelengths can be chosen according to a known behavior of an arthropod of interest.

In some embodiments, the spectrum is selected according to known characteristics of an arthropod of interest.

In some embodiments, the reflective polarization coating reflects light comprising a selected spectrum of wavelengths, the wavelengths consisting of light falling within a spectral range selected from the group consisting of: UV, blue, green, yellow, and red.

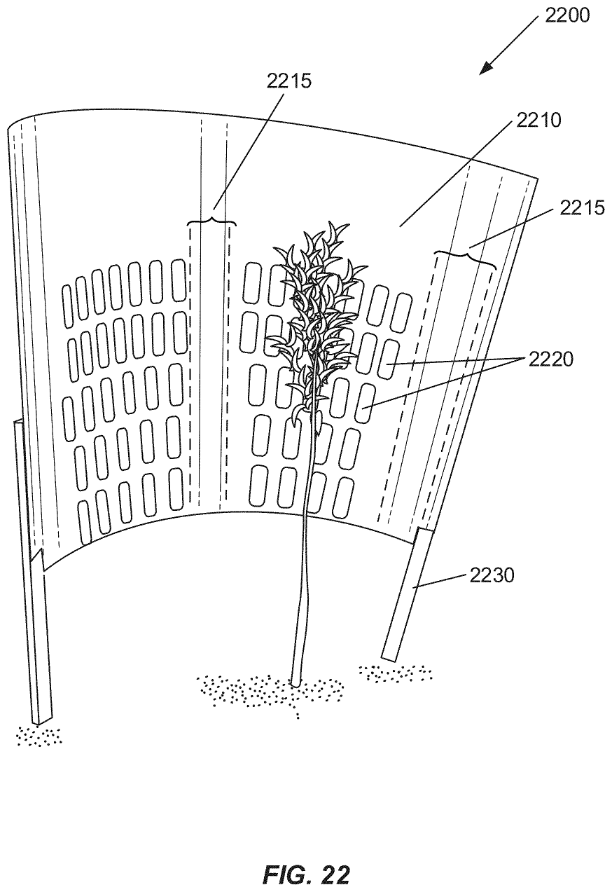

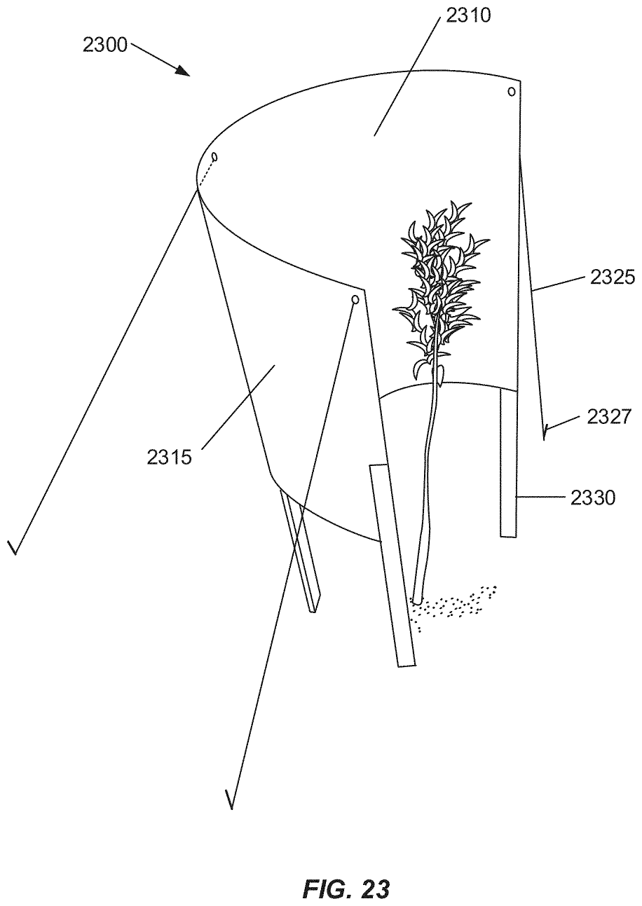

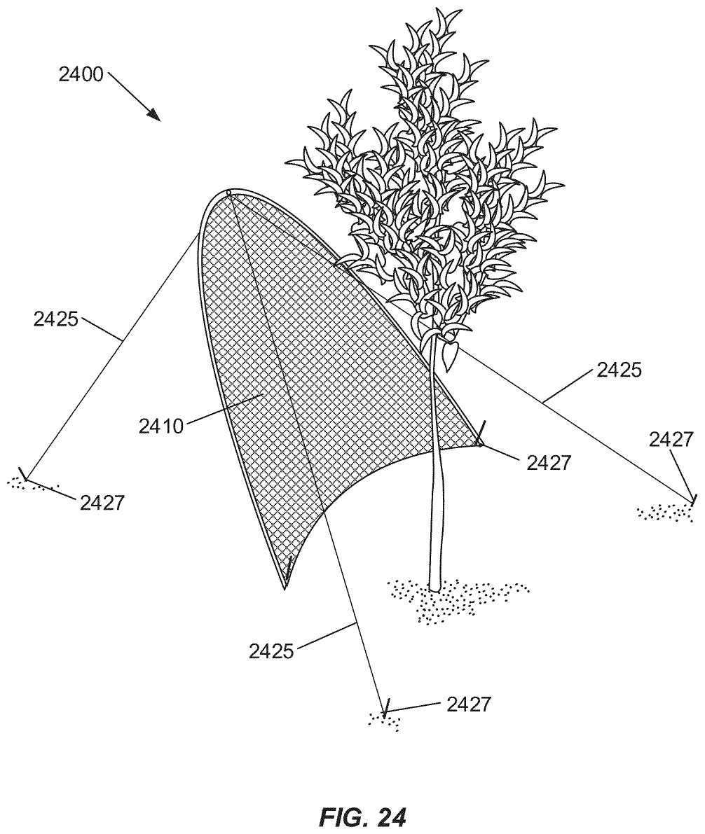

In still further alternative embodiments, as illustrated in FIGS. 22-24, a simplified variant of the growth chamber has been developed and tested.

Referring now to FIGS. 22-24; a light-reflective growth stimulator 2200, 2300, 2400, for enriching a light environment to a crop plant is illustrated, comprising a flexible reflective panel 2210, 2310 having a first photoselective reflective surface, configured to face the crop plant, having properties for directing solar energy comprising selected red or yellow light wavelengths directed toward the crop plant and placed in proximity to said agricultural crop plant. The photoselective reflective surface reduces blue light wavelengths directed toward the agricultural crop plant.

In some embodiments, the flexible reflective panel further comprises a plurality of wind resistance reduction features 2220.

In some embodiments, the flexible reflective panel comprises photoselective netting 2410.

In some embodiments, the flexible reflective panel comprises a second photoselective reflective surface 2315 having properties for spectral manipulation of light for insect pest control, wherein the second photoselective reflective surface reflects light selected according to known characteristics of an arthropod of interest.

In some embodiments, the flexible reflective panel 2210, 2310, 2410 is a shade of red specifically intended to affect light with light of at least one wavelength selected from the range of wavelengths of from 400 nm to 700 nm.

In some embodiments, a side opposite the reflective surface 2315 reflects light comprising a selected spectrum of wavelengths, the wavelengths consisting of light falling within a spectral range selected from the group consisting of: yellow; pearl-white; highly reflective metallic silver or gold; and adjacent shades in the spectrum thereof.

In some embodiments, the light-reflective growth stimulator further comprises additional reflective regions 2215 between the plurality of wind resistance reduction features 2220.

In any embodiment of the light-reflective growth stimulator, the flexible reflective panel 2210, 2310, 2410 is elevated between 6 inches and 2 feet off the ground using extensions or legs 2230, 2330. The extensions or legs provide clearance off the ground, thus avoiding the accumulation of leaves, debris and/or litter that might otherwise accumulate and diminish the effectiveness of the light-reflective growth stimulator.

In some embodiments, the light-reflective growth stimulator further comprises wind support lines 2325, 2425 and/or structure anchors 2327, 2427 to provide additional stability to the structures.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A method of collecting and concentrating solar energy to a growing grape vine or grape vine replant, comprising:
collecting and concentrating solar energy with a solar concentrator comprising a solar-facing surface positioned above the agricultural crop plant, the solar-facing surface comprising a reflective material;
directing the collected solar energy toward the growing grape vine or grape vine replant through a light transmitter in optical communication with the solar concentrator, the light transmitter comprising: an inner wall comprising a perimeter positioned between the solar concentrator and the growing grape vine or grape vine replant, the inner wall further comprising a reflective inner surface for directing collected solar energy toward the growing grape vine or grape vine replant;
positioning a protective inner surface defining a protected zone surrounding the agricultural crop plant, the protective inner surface extending downward from the light transmitter and comprising a rigid outer wall for protecting the protected zone from one or more growth limiting factors selected from the group consisting of: wind damage; heat damage; cold damage; frost damage; herbicide damage; and animal damage; and/or for reducing evapo-transpiration by the agricultural crop plant positioned in the protected zone,
wherein one or both of the light transmitter and the protective inner surface comprise one or more openings for allowing one or both of a) operator access to the growing grape vine or grape vine replant therethrough and b) airflow between an outside environment and the protected zone.

2. The method of claim 1, wherein the protective inner surface and the light transmitter are integrally connected to one another.

3. The method of claim 1, wherein the protective inner surface, the light transmitter, and the solar concentrator are integrally connected to one another.

4. The method of claim 1, wherein the one or more openings comprise one or more pairs of openings positioned on laterally opposing sides of the light transmitter or protective inner surface from one another, to allow lateral airflow through the light transmitter or protective inner surface.

5. The method of claim 1, wherein the solar concentrator comprises one or more elements selected from the group consisting of: a funnel shape, a cone shape, a parabolic shape, a partial funnel shape, a partial cone shape, and a compound or partial parabolic shape.

6. The method of claim 1, wherein one or both of the reflective material and the reflective inner surface comprise a plastic material.

7. The method of claim 1, wherein one or both of the reflective material and the reflective inner surface are red in color.

8. The method of claim 1, wherein one or both of the reflective material and the reflective inner surface are adapted to limit or eliminate reflection of blue light.

9. The method of claim 1, wherein one or both of the reflective material and the reflective inner surface are adapted to limit or eliminate reflection of ultraviolet (UV) light.

10. The method of claim 1, wherein the rigid outer wall defines an upper perimeter for engaging the light transmitter and a lower perimeter for engaging a soil surface surrounding the growing grape vine or grape vine replant, and wherein the lower perimeter is smaller than the upper perimeter.

11. The method of claim 1, wherein one or both of the light transmitter and the protective inner surface comprise one or more vertical openings comprising; edges, joints and a hinge, such that one or both of the light transmitter and the protective inner surface is configurable to be opened or closed along the one or more vertical openings, thereby allowing air to pass the outside environment and the protected zone.

12. The method of claim 1, further comprising attaching one or more heat sinks to one or both of the light transmitter and the protective inner surface, for gathering at least a portion of the collected solar energy in the one or more heat sinks at one time and releasing the gathered solar energy into the protected zone at a later time.

13. The method of claim 1, wherein the protective inner surface and the light transmitter are connected to one another through an interlocking connection.

14. The method of claim 1, wherein the solar concentrator and the light transmitter are connected to one another through an interlocking connection.

15. The method of claim 1, wherein the solar concentrator, the light transmitter, and the protective inner surface are connected to one another through an interlocking connection.

16. The method of claim 1, wherein the solar concentrator and the light transmitter are connected to one another through a rotary connection.

17. The method of claim 1, wherein the rigid outer wall defines one or more members selected from the group consisting of: a funnel shape, a cone shape, a parabolic shape, a partial funnel shape, a partial cone shape, and a compound or partial parabolic shape.

18. The method of claim 1, wherein the rigid outer wall defines an upper perimeter for engaging the light transmitter and a lower perimeter for engaging a soil surface surrounding the growing grape vine or grape vine replant, and wherein the lower perimeter is smaller than the upper perimeter.

19. The method of claim 1, wherein the protective inner surface is supported on soil surrounding the growing grape vine or grape vine replant on one or more legs extending from the protective inner surface or from the light transmitter.

20. The method of claim 1, wherein one or both of the light transmitter and the protective inner surface are tube shaped.

21. The method of claim 12, wherein the one or more heat sinks are circular in shape defining an opening for surrounding the growing grape vine or grape vine replant.

22. The method of claim 12, wherein the one or more heat sinks comprise one circular portion or two or more partial circular portions that engage one another to form the circular shape.

23. The method of claim 1, further comprising training the growing grape vine or grape vine replant to grow in a desired direction by positioning the protective inner surface and the inner wall adjacent to the growing grape vine or grape vine replant and in a desired direction.

24. The method of claim 1, further comprising scattering, manipulating the spectral composition, or both, of the collected solar energy before the collected solar energy is directed to the growing grape vine or grape vine replant.

25. The method of claim 24, wherein the manipulating the spectral composition comprises one or more members selected from the group consisting of: reducing blue light, enriching relative content of light in the yellow or red or far-red spectral regions, reducing relative content of UV radiation, reducing relative content of UVB radiation, and reducing relative content of infrared (IR) radiation compared to the collected solar energy.

26. The method of claim 24, wherein the manipulating the spectral composition comprises (i) enriching relative content of light in each of the yellow, red, and far-red spectral regions by at least about 10% compared to the collected solar energy or (ii) reducing blue light by at least about 20% compared to the collected solar energy.

27. The method of claim 24, wherein the manipulating the spectral composition comprises enriching one or more photosynthetically active radiation (PAR) wavelengths with a range from about 400-700 nanometers (nm), about 540-750 nm, and/or about 620-750 nm compared to the collected solar energy.

28. The method of claim 24, wherein the manipulating the spectral composition comprises reducing relative content of UVB radiation by at least about 50% compared to the collected solar energy.

29. The method of claim 24, wherein manipulating the spectral composition comprises filtering the collected solar energy within ranges of wavelengths from about 400-700 nm, about 540-750 nm, and/or about 620-750 nm compared to the collected solar energy.

30. The method of claim 1, wherein one or both of the reflective material and the reflective inner surface comprise a plastic material.
